(19) United States
(12) Patent Application Publication
(10) Pub. No.: US 2026/0051020 A1
(43) Pub. Date: Feb. 19, 2026

(54) Systems and Methods for Panorama Generation with Seams using a Saliency-based Object of Interest

(71) Applicant: Google LLC, Mountain View, CA (US)

(72) Inventors: Lun-Cheng Chu, Milpitas, CA (US); Ruchika Sachin Saswade, San Jose, CA (US); Gang Sun, San Jose, CA (US); Ying Ru Lai, Taipei (TW); Chui Min Chiu, Tayyuan (TW); Oleksandr Getman, Hwaseong City (HK); Miao Yu, Cupertino, CA (US); Chia-Kai Liang, Cupertino, CA (US); Hungwei Hsu, Taipei (TW); Lawrence Chia-Yu Huang, Santa Clara, CA (US); Brandon Christopher Low, Sunnyvale, CA (US); Mertin Curban-Gazi, San Francisco, CA (US); Arthur Kim, Brooklyn, NY (US); Michael Edward Specht, Chattahoochee Hills, GA (US); Maayan Rebeca Rossmann Segal, Sunnyvale, CA (US); Tristan Blake Greszko, Jackson, WV (US); Salma Doghraji, San Francisco, CA (US)

(21) Appl. No.: 19/296,284

(22) Filed: Aug. 11, 2025

Related U.S. Application Data
(60) Provisional application No. 63/682,785, filed on Aug. 13, 2024.

(51) Int. Cl. G06T 3/4038; G06T 7/50

(52) U.S. Cl. CPC G06T 3/4038; G06T 7/50; G06T 2200/32; G06T 2210/22

(57) ABSTRACT

An example method includes receiving, by a computing device, a plurality of image frames. The method also includes determining, by the computing device, one or more objects of interest within the plurality of image frames, wherein the determining is based on saliency heat maps indicative of the one or more objects of interest. The method further includes determining at least one seam corresponding to at least one pair of successive image frames of the plurality of image frames, wherein the determining of the at least one seam is based on respective weights associated with the one or more objects of interest. The method additionally includes stitching together, by the computing device and based on the at least one seam, the at least one pair of successive image frames to generate a panorama image.

### CROSS REFERENCE TO RELATED APPLICATIONS

This application claims priority to U.S. Provisional Patent Application No. 63/682,785, filed Aug. 13, 2024, the contents of which are incorporated herein by reference in their entirety.

### BACKGROUND

In image processing, “image stitching” is a process that involves combining together several individual image frames into a composite image, for example, a panoramic image. While many approaches exist, most stitching algorithms rely on individual image frames that contain at least some overlapping regions. Such stitching algorithms generally identify distinctive features in the overlapping regions and then match the features to establish correspondences between the individual image frames. After that, the stitching algorithms generally blend together corresponding image frames at the overlapping regions to create a final composite image.

### SUMMARY

Moving subjects have been a persistent technical hurdle for panorama images. This occurrence complicates alignment, introduces ghosting artifacts, and compromises user experience. The approach described herein is based on compensating stitching results using real-captured pixels across input frames. In other words, no inpainting or generative technology is involved. A weighted subject heatmap may be generated for each input frame by leveraging the subject probability map with edge smoothing. The heatmap may be consolidated along with matching errors from other camera modules during seam finding to make blending and stitching decisions.

Example embodiments involve a computing device that performs image stitching. The computing device may include a seam selection module operable to select a scam based on saliency heat maps for objects of interest. The computing device may also include a stitching module operable to stitch together the adjacent image frames based on the selected seam. Using these two modules, the computing device could generate composite images, such as panoramic images, and then display those composite images to users.

In one aspect, a computer-implemented method is provided. The method includes receiving, by a computing device, a plurality of image frames. The method also includes determining, by the computing device, one or more objects of interest within the plurality of image frames, wherein the determining is based on saliency heat maps indicative of the one or more objects of interest. The method further includes determining at least one seam corresponding to at least one pair of successive image frames of the plurality of image frames, wherein the determining of the at least one seam is based on respective weights associated with the one or more objects of interest. The method additionally includes stitching together, by the computing device and based on the at least one seam, the at least one pair of successive image frames to generate a panorama image.

In another aspect, a system is provided. The system may include one or more processors. The system may also include data storage, where the data storage has stored thereon computer-executable instructions that, when executed by the one or more processors, cause the system to carry out operations. The operations may include receiving, by a computing device, a plurality of image frames. The operations may also include determining, by the computing device, one or more objects of interest within the plurality of image frames, wherein the determining is based on saliency heat maps indicative of the one or more objects of interest. The operations may additionally include determining at least one seam corresponding to at least one pair of successive image frames of the plurality of image frames, wherein the determining of the at least one seam is based on respective weights associated with the one or more objects of interest. The operations may also include stitching together, by the computing device and based on the at least one seam, the at least one pair of successive image frames to generate a panorama image.

In another aspect, a computing device is provided. The device includes a primary camera and a secondary camera that share a common field of view. The device also includes one or more processors and data storage that has stored thereon computer-executable instructions that, when executed by the one or more processors, cause the computing device to carry out operations. The operations may include receiving, by a computing device, a plurality of image frames. The operations may also include determining, by the computing device, one or more objects of interest within the plurality of image frames, wherein the determining is based on saliency heat maps indicative of the one or more objects of interest. The operations may additionally include determining at least one seam corresponding to at least one pair of successive image frames of the plurality of image frames, wherein the determining of the at least one seam is based on respective weights associated with the one or more objects of interest. The operations may also include stitching together, by the computing device and based on the at least one seam, the at least one pair of successive image frames to generate a panorama image.

In another aspect, an article of manufacture is provided. The article of manufacture may include a non-transitory computer-readable medium having stored thereon program instructions that, upon execution by one or more processors of a computing device, cause the computing device to carry out operations. The operations may include receiving, by a computing device, a plurality of image frames. The operations may also include determining, by the computing device, one or more objects of interest within the plurality of image frames, wherein the determining is based on saliency heat maps indicative of the one or more objects of interest. The operations may additionally include determining at least one seam corresponding to at least one pair of successive image frames of the plurality of image frames, wherein the determining of the at least one seam is based on respective weights associated with the one or more objects of interest. The operations may also include stitching together, by the computing device and based on the at least one seam, the at least one pair of successive image frames to generate a panorama image.

In another aspect, a program is provided. The program upon execution by one or more processors of a computing device, causes the computing device to carry out operations. The operations may include receiving, by a computing device, a plurality of image frames. The operations may also include determining, by the computing device, one or more objects of interest within the plurality of image frames, wherein the determining is based on saliency heat maps indicative of the one or more objects of interest. The operations may additionally include determining at least one seam corresponding to at least one pair of successive image frames of the plurality of image frames, wherein the determining of the at least one seam is based on respective weights associated with the one or more objects of interest. The operations may also include stitching together, by the computing device and based on the at least one seam, the at least one pair of successive image frames to generate a panorama image.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is an illustration of front, right-side, and rear views of a digital camera device 100, in accordance with example embodiments.

FIG. 2 illustrates a seam selection process without subject-based adjustments, in accordance with example embodiments.

FIG. 3 illustrates a seam selection process with subject-based adjustments, in accordance with example embodiments.

FIG. 4A illustrates a panorama image with and without subject-based adjustments, in accordance with example embodiments.

FIG. 4B illustrates another panorama image with and without subject-based adjustments, in accordance with example embodiments.

FIG. 5 illustrates a panorama image with and without subject-based adjustments, in accordance with example embodiments.

FIG. 6 illustrates a panorama image with and without subject-based adjustments, in accordance with example embodiments.

FIG. 7 illustrates a comparison between rerunning the auto exposure (AE) logic and using a tonemapping algorithm, in accordance with example embodiments.

FIG. 8 illustrates example projections, in accordance with example embodiments.

FIG. 9 illustrates example projections, in accordance with example embodiments.

FIG. 10 illustrates example alignments, in accordance with example embodiments.

FIG. 11 illustrates example tile-based alignment, in accordance with example embodiments.

FIG. 12 illustrates adaptive shading compensation, in accordance with example embodiments.

FIG. 13 illustrates an example of a shading compensation, in accordance with example embodiments.

FIG. 14 illustrates another example of a shading compensation, in accordance with example embodiments.

FIG. 15 illustrates an example image cropping, in accordance with example embodiments.

FIG. 16 illustrates an example image brightness adjustment, in accordance with example embodiments.

FIG. 17 illustrates an example removal of a ghosting artifact, in accordance with example embodiments.

FIG. 18 illustrates an example first instance of a user interface for panorama generation, in accordance with example embodiments.

FIG. 19 illustrates an example second instance of a user interface for panorama generation, in accordance with example embodiments.

FIG. 20 illustrates an example third instance of a user interface for panorama generation, in accordance with example embodiments.

FIG. 21 illustrates an example fourth instance of a user interface for panorama generation, in accordance with example embodiments.

FIG. 22 illustrates an example fifth instance of a user interface for panorama generation, in accordance with example embodiments.

FIG. 23 is a block diagram of an example computing device, in accordance with example embodiments.

FIG. 24 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

Some example image stitching processes include several phases such as seam selection, feature detection, alignment, and/or blending. The seam selection phase involves selecting a seam for successive image frames. The feature detection phase involves identifying corresponding features in the successive image frames. The alignment phase involves transforming at least some of the successive image frames to align the identified features. And the blending phase involves merging together the aligned frames into a single composite image.

Many image stitching processes are based on a rigid design that prevents seamless integration with other modules, and hinders customization. Also, for example, the scam selection is pixel based, and stitching can be resource intensive. As described herein, a tile-based approach is described where the seam selection and stitching may be tile-based instead of pixel based. This is especially useful when implemented on mobile devices. Also, for example, generating panorama relies on video frames as input, which often leads to blurry or pixelated panoramas due to the lower quality of video frames compared to still images.

Many image stitching processes include a blending phase that also does not attempt to discriminate between objects of interest, foreground objects, background objects, and/or the quality of an object, multiple appearance of the same object, etc. As a result, when blending together two image frames, such image stitching processes often place seams directly over objects of interest, thereby causing artifacts and/or other distortions to appear on those objects of interest. This problem can also be disadvantageous in terms of image fidelity and could also reduce the overall quality of the composite images generated from these image stitching processes.

There are other technical challenges related to panorama generation. For example, it can be challenging to integrate a linear data pipeline of an enhanced high dynamic range (HDR) processing into the stitching engine. It may be challenging to perform tone adjustment across a sequence of image frames of drastically different image conditions. Also, for example, a higher image resolution may require more system resources during the capture and stitching process, which can be a strain on system health. As another example, the capturing process may be frame by frame (about 30 degrees apart), which can increase the likelihood of ghosting artifacts.

The present disclosure provides for an image stitching process that may help to address these issues. More specifically, example image stitching processes intelligently select seams by considering the quality of the objects of interest. Example image stitching processes may also penalize seams placed on objects of interest during the blending phase. Advantageously, the disclosed image stitching processes allow for the generation of composite images that contain high quality objects of interest therein. High image quality may be achieved in challenging low light situations. Banding artifacts, ghosting artifacts, motion artifacts, and so forth may be removed or minimized.

Generally, the stitching engine may receive a sequence of linear enhanced HDR image frames once the image capture begins, processes them in parallel, and generates the final gamma panorama image as output.

The disclosed process could be implemented by a computing device, such as a mobile device, a server device, or another type of computing device. The objects of interest could correspond to human faces, buildings, vehicles, or animals, among other possibilities.

The computing device could also include a stitching module operable to stitch together the image frames to create a composite image. While performing the stitching, the stitching module could implement a seam finding process that adds a computational bias to scams placed on regions of interest within the image frames. One strategy may be to select a seam that traverses highly aligned portions of an overlapping region between successive image frames. In some examples, this computational bias involves adding a penalty term to any seam that contains pixels from the objects of interest.

In some examples, the disclosed process may be implemented by the same device that captured the one or more image frames. For instance, after the computing device captures one or more image frames, the seam selection module can be invoked to select a scam and the stitching module could be invoked to create a composite image based on selected seams. The composite image can be displayed, communicated, stored, and/or otherwise utilized; e.g., printed to paper. In other examples, the seam selection and/or stitching processes may be implemented by a device that is separate but communicatively coupled to the device that captured the one or more image frames.

In some examples, image frames may be stitched together from a successive image stream (e.g., a video stream). The image stream may be captured by a front facing camera (e.g., user facing) of a computing device, a rear facing camera (e.g., non-user facing) of the computing device, or another camera of the computing device. In some cases, the successive image stream may be captured using multiple cameras of the computing device, for example, the front facing camera and the rear facing camera.

In some examples, a composite image may be generated with minimal or no user input. For instance, the composite image may be generated without requesting that a user identify regions of interest, objects of interests, or other aspects of an image frame. Additionally, the composite image may be generated without requesting that the user capture the one or more image frames using a specific gesture (e.g., scanning a scene horizontally with the computing device). Automatic image stitching applications may benefit by not requiring such user inputs. However, variations of the herein-described processes with one or more types of user input are contemplated as well.

These as well as other aspects, advantages, and alternatives will become apparent to those reading the following description, with reference where appropriate to the accompanying drawings. Further, it should be understood that the discussion in this overview and elsewhere in this document is provided by way of example only and that numerous variations are possible.

### Example Camera Systems

As image capture devices, such as cameras, become more popular, they may be employed as standalone hardware devices or integrated into various other types of devices. For instance, still and video cameras are now regularly included in wireless computing devices (e.g., mobile devices, such as mobile phones), tablet computers, laptop computers, video game interfaces, home automation devices, and even automobiles and other types of vehicles.

The physical components of a camera may include one or more apertures through which light enters, one or more recording surfaces for capturing the images represented by the light, and lenses positioned in front of each aperture to focus at least part of the image on the recording surface(s). The apertures may be of a fixed size or may be adjustable. In an analog camera, the recording surface may be a photographic film. In a digital camera, the recording surface may include an electronic image sensor (e.g., a charge coupled device (CCD) or a complementary metal-oxide-semiconductor (CMOS) sensor) to transfer and/or store captured images in a data storage unit (e.g., memory).

One or more shutters may be coupled to, or positioned near, the lenses or the recording surfaces. Each shutter may either be in a closed position, in which it blocks light from reaching the recording surface, or an open position, in which light is allowed to reach the recording surface. The position of each shutter may be controlled by a shutter button. For instance, a shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position.

Alternatively, the shuttering process may be electronic. For example, before an electronic shutter of a CCD image sensor is “opened,” the sensor may be reset to remove any residual signal in its photodiodes. While the electronic shutter remains open, the photodiodes may accumulate charge. When or after the shutter closes, these charges may be transferred to longer-term data storage. Combinations of mechanical and electronic shuttering may also be possible.

Regardless of type, a shutter may be activated and/or controlled by something other than a shutter button. For instance, the shutter may be activated by a softkey, a timer, or some other trigger. Herein, the term “capture” may refer to any mechanical and/or electronic shuttering process that results in one or more images being recorded, regardless of how the shuttering process is triggered or controlled.

The exposure of a captured image may be determined by a combination of the size of the aperture, the brightness of the light entering the aperture, and the length of the shutter cycle (also referred to as the shutter length, the exposure length, or the exposure time). Additionally, a digital and/or analog gain (e.g., based on an ISO setting) may be applied to the image, thereby influencing the exposure. In some embodiments, the term “exposure length,” “exposure time,” or “exposure time interval” may refer to the shutter length multiplied by the gain for a particular aperture size. Thus, these terms may be used somewhat interchangeably, and should be interpreted as possibly being a shutter length, an exposure time, and/or any other metric that controls the amount of signal response that results from light reaching the recording surface.

In some implementations or modes of operation, a camera may capture one or more still images each time image capture is triggered. In other implementations or modes of operation, a camera may capture a video image by continuously capturing images at a particular rate (e.g., 24 frames per second) as long as image capture remains triggered (e.g., while the shutter button is held down). Some cameras, when operating in a mode to capture a still image, may open the shutter when the camera device or application is activated, and the shutter may remain in this position until the camera device or application is deactivated. While the shutter is open, the camera device or application may capture and display a representation of a scene on a viewfinder (sometimes referred to as displaying a “preview frame”). When image capture is triggered, one or more distinct payload images of the current scene may be captured.

Cameras, including digital and analog cameras, may include software to control one or more camera functions and/or settings, such as aperture size, exposure time, gain, and so on. Additionally, some cameras may include software that digitally processes images during or after image capture. While the description above refers to cameras in general, it may be particularly relevant to digital cameras. Digital cameras may be standalone devices (e.g., a DSLR camera) or may be integrated with other devices.

Either or both of a front-facing camera and a rear-facing camera may include or be associated with an ambient light sensor (ALS) that may continuously or from time to time determine the ambient brightness of a scene that the camera can capture. In some devices, the ALS can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

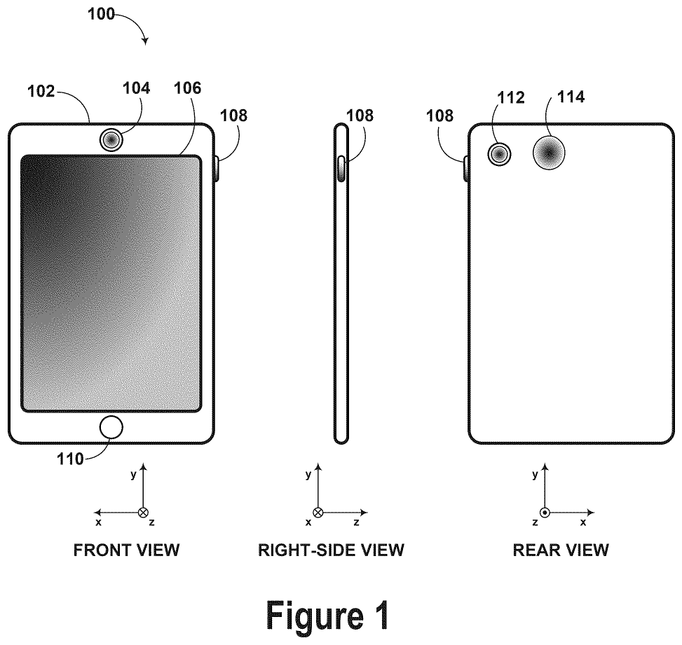

FIG. 1 is an illustration of front, right-side, and rear views of a digital camera device 100, in accordance with example embodiments. Digital camera device 100 may be, for example, a mobile device (e.g., a mobile phone), a tablet computer, or a wearable computing device. However, other embodiments are possible. Digital camera device 100 may include various elements, such as a body 102, a front-facing camera 104, a multi-element display 106, a shutter button 108, and other buttons 110. Digital camera device 100 could further include one or more rear-facing cameras 112, 114. Front-facing camera 104 may be positioned on a side of body 102 typically facing a user while in operation, or on the same side as multi-element display 106. Rear-facing cameras 112, 114 may be positioned on a side of body 102 opposite front-facing camera 104. Referring to the cameras as front-facing and rear-facing is arbitrary, and digital camera device 100 may include multiple cameras positioned on various sides of body 102.

Multi-element display 106 could represent a cathode ray tube (CRT) display, a light-emitting diode (LED) display, a liquid crystal display (LCD), a plasma display, or any other type of display known in the art. In some embodiments, multi-element display 106 may display a digital representation of the current image being captured by front-facing camera 104 and/or rear-facing cameras 112, 114, or an image that could be captured or was recently captured by either or both of these cameras. Thus, multi-element display 106 may serve as a viewfinder for either camera. Multi-element display 106 may also support touchscreen and/or presence-sensitive functions that may be able to adjust the settings and/or configuration of any aspect of digital camera device 100.

Multi-element display 106 may include additional features related to a camera application. For example, multiple modes may be available for a user, including, a motion mode, portrait mode, video mode, video bokeh mode, and so forth. The camera application may be in camera mode and provide additional features, such as a reverse icon to activate reverse camera view, a trigger button to capture a previewed image, and a photo stream icon to access a database of captured images. Also for example, a magnification ratio slider may be displayed and a user can move a virtual object along the magnification ratio slider to select a magnification ratio. In some embodiments, a user may use the multi-element display 106, also referred to herein as the display screen, to adjust the magnification ratio (e.g., by moving two fingers on display screen in an outward motion away from each other), and magnification ratio slider may automatically display the magnification ratio.

Front-facing camera 104 may include an image sensor and associated optical elements such as lenses. Front-facing camera 104 may offer zoom capabilities or could have a fixed focal length. In other embodiments, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent a monoscopic, stereoscopic, or multiscopic camera. Rear-facing cameras 112, 114 may be similarly or differently arranged. Additionally, front-facing camera 104, rear-facing cameras 112, 114, or both, may be an array of one or more cameras.

Either or both of front-facing camera 104 and rear-facing cameras 112, 114 may include or be associated with an illumination component that provides a light field to illuminate a target object. For instance, an illumination component could provide flash or constant illumination of the target object (e.g., using one or more LEDs). An illumination component could also be configured to provide a light field that includes one or more of structured light, polarized light, and light with specific spectral content. Other types of light fields known and used to recover three-dimensional (3D) models from an object are possible within the context of the embodiments herein.

In some digital camera devices 100, either or both of front-facing camera 104 and rear-facing cameras 112, 114 may include or be associated with an ambient light sensor that may continuously or from time to time determine the ambient brightness of a scene that the camera can capture. In some devices, the ambient light sensor can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

Digital camera device 100 could be configured to use multi-element display 106 and either front-facing camera 104 or rear-facing cameras 112, 114 to capture images of a target object (e.g., a subject within a scene). The captured images could be a plurality of still images or a video image (e.g., a series of still images captured in rapid succession with or without accompanying audio captured by a microphone). The image capture could be triggered by activating shutter button 108, pressing a softkey on multi-element display 106, or by some other mechanism. Depending upon the implementation, the images could be captured automatically at a specific time interval, for example, upon pressing shutter button 108, upon appropriate lighting conditions of the target object, upon moving digital camera device 100 a predetermined distance, or according to a predetermined capture schedule.

As noted above, the functions of digital camera device 100 (or another type of digital camera) may be integrated into a computing device, such as a wireless computing device, cell phone, tablet computer, laptop computer, and so on. For example, a camera controller may be integrated with the digital camera device 100 to control one or more functions of the digital camera device 100.

### Example Methods for Seam Selection

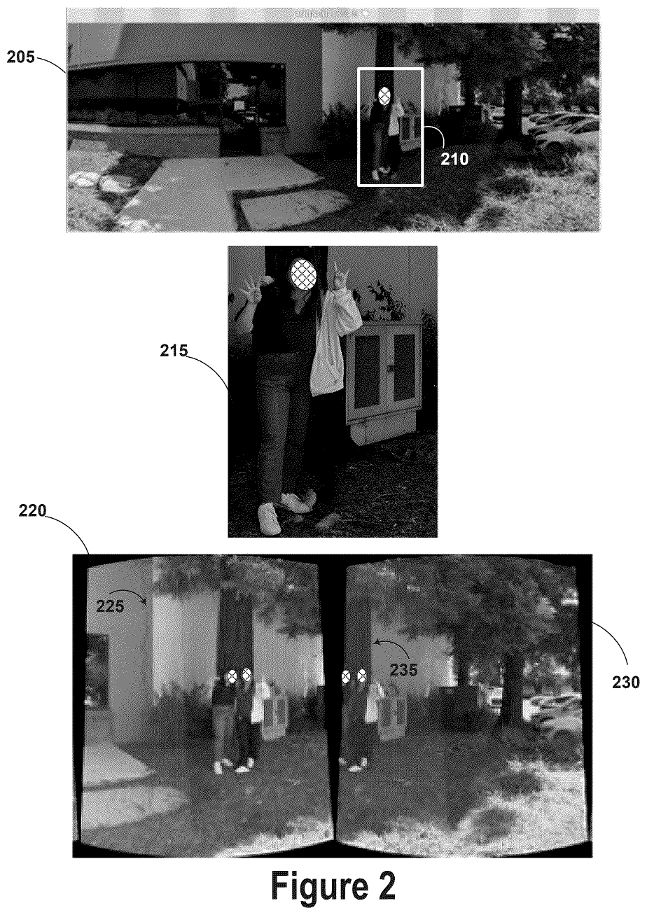

FIG. 2 illustrates a seam selection process without subject-based adjustments, in accordance with example embodiments. Image 205 illustrates how an approach to generating a panorama image without subject-based adjustments can lead to discrepancies and/or distortions, such as a possible fusion of two objects of interest, as indicated by bounding box 210. Image 215 is an enlarged view of the portion of the image within bounding box 210. Although two separate pairs of legs are discernible, the upper portions of the two bodies have become fused together. Two successive image frames, first frame 220 and second frame 230, illustrate a seam selection process that may cause such discrepancies and/or distortions. For example, first seam 225 in first frame 220 and second seam 235 in second frame 230 are shown. As illustrated, second seam 235 passes through the body of the individual standing to the right.

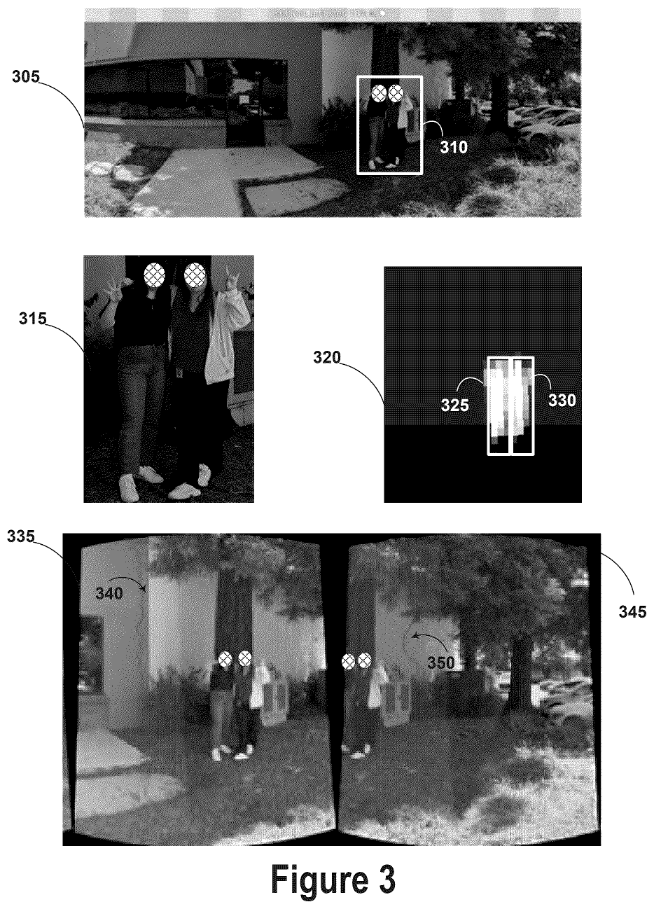

FIG. 3 illustrates a seam selection process with subject-based adjustments, in accordance with example embodiments. Image 305 illustrates how an approach to generating a panorama image with subject-based adjustments can eliminate and/or reduce discrepancies and/or distortions, such as a possible fusion of two objects of interest. As indicated by bounding box 310, image 305 includes two separate individuals standing close together. Image 315 is an enlarged view of the portion of the image within bounding box 310, and shows the individuals without the discrepancies and/or distortions seen in image 205 of FIG. 2 (e.g., the upper portions of the two bodies are not fused together).

Some embodiments involve determining one or more objects of interest within the plurality of image frames, wherein the determining is based on saliency heat maps indicative of the one or more objects of interest. For example, a weighted subject heatmap may be determined for an image frame by leveraging a subject probability map with edge smoothing. The heatmap may be consolidated along with matching errors from the other camera modules during scam finding to make blending and stitching decisions.

Image 320 illustrates a saliency heat map indicating the two objects of interest (e.g., the two individuals). In some embodiments, each of the one or more objects of interest may correspond to a human subject. For example, respective weights associated with the two objects of interest may indicate a presence of two separate individuals. For example, first bounding box 325 includes a saliency heat map corresponding to the first individual, and second bounding box 330 includes a saliency heat map corresponding to the second individual.

Some embodiments involve determining at least one seam corresponding to at least one pair of successive image frames of the plurality of image frames, wherein the determining of the at least one seam is based on respective weights associated with the one or more objects of interest. Two successive image frames, first frame 335 and second frame 345, illustrate a scam selection process that can eliminate and/or reduce discrepancies and/or distortions. For example, first seam 340 in first frame 335 and second seam 350 in second frame 345 are shown. As illustrated, unlike second scam 235 of FIG. 2, second seam 350 is designed to not pass through the body of the individual standing to the right.

In some embodiments, the determining of the at least one seam involves adding a computational bias to seams that contain pixels from the one or more objects of interest. For example, the computational bias may include adding a penalty term to any seam that contains pixels from the one or more identified regions of interest. For example, a penalty term may be added to any scam that passes through the body of the individual standing to the right. The penalty term can discourage selection of such seams. Also, for example, a boost term may be added to any seam that does not pass through the body of the individual standing to the right. The boost term can encourage selection of such seams.

In some embodiments, the saliency heat maps indicative of the one or more objects of interest may indicate two overlapping objects of interest. The determining of the at least one seam involves preserving the two overlapping objects of interest in their entirety. For example, second seam 350 in second frame 345 ensures that the individuals remain intact in the panorama image 310 without the discrepancies and/or distortions seen in image 205 of FIG. 2 (e.g., the upper portions of the two bodies are not fused together).

Heat maps are typically used to detect salient objects and/or regions of interest. As described herein, a heat map may be used to determine when an object of interest (ROI) is significantly salient (e.g., where a saliency score based on the heat map exceeds a threshold saliency score). The term “object of interest” as used herein, generally refers to a bounding contour or a bounding box that indicates a portion of an image that includes an object. For example, the object may be a human face, and the bounding contour may be a circle around the human face. As another example, the object may be a flower pot and the bounding contour may be a bounding box that includes the flower pot. In some embodiments, an object of interest may be indicated by a user. For example, the user may interact with a preview of a scene and select an object in a multimodal manner, such as by typing an identity of the object, giving voice instructions to the camera device, touching the object in the preview, hovering over the object in the preview, and so forth. In some embodiments, the object may be detected automatically (e.g., an object detection algorithm, a face detection algorithm, a segmentation algorithm, and so forth), and a bounding contour may be automatically generated for the detected object. In some implementations, a user-approved facial recognition algorithm may be applied to identify one or more individuals and generate bounding contours for such detected individuals.

In some embodiments, the generating of the one or more saliency heat maps is performed by a machine learning model. For example, a machine-learned technique (“Saliency Model”) may be used to predict a saliency heat map for a given image frame. The Saliency Model may be implemented as one or more of a support vector machine (SVM), a recurrent neural network (RNN), a convolutional neural network (CNN), a dense neural network (DNN), other machine-learning techniques, and/or a combination thereof. The saliency heat map depicts the magnitude of the saliency probability on a scale (e.g., from black to white, where white indicates a high probability of saliency and black indicates a low probability of saliency). Each pixel within the saliency heat map may be assigned a saliency metric that represents how salient the region represented by the metric is based on a computing device applying a pre-trained machine learning model to the image frame, such that the pre-trained machine learning model outputs a saliency metric for each pixel within the saliency heat map.

In some embodiments, the Saliency Model may produce a bounding box enclosing the region with the greatest probability of saliency. The saliency heat map may be used to determine one or more objects of interest in an image, and generate one or more bounding boxes around the determined objects of interest. In some embodiments, anchor boxes of various aspect ratios and sizes located at various portions of the image may be used to determine an object of interest. In some aspects, the object of interest may be a portion of the image with a high or the highest average saliency value. For example, each pixel in the heat map may be associated with a saliency value, and an average of the saliency values of the pixels within the anchor bounding box may be used to determine the average saliency value.

In some embodiments, average saliency values of anchor bounding boxes of various sizes and aspect ratios may be assessed every few pixels. For example, the center of the anchor bounding boxes may be evenly spaced based on a stride value, and at each location, various sizes and aspect ratios of the anchor bounding boxes may be assessed to identify objects of interest. For example, an anchor bounding box with a maximum average saliency value may be selected as a primary object of interest. Other anchor bounding boxes that overlap with the selected anchor bounding box, and/or are less than a threshold distance away from the selected primary object of interest are discarded. A secondary object of interest may then be selected, and so forth.

For example, a primary object of interest may be determined to be an object of interest with a maximum average saliency. Next, based on the primary object of interest, a secondary object of interest may be determined to be an object of interest with pixels of a lesser average saliency value when compared with the primary object of interest. Also, for example, the secondary object of interest may be required to be at least a threshold distance away from the primary object of interest.

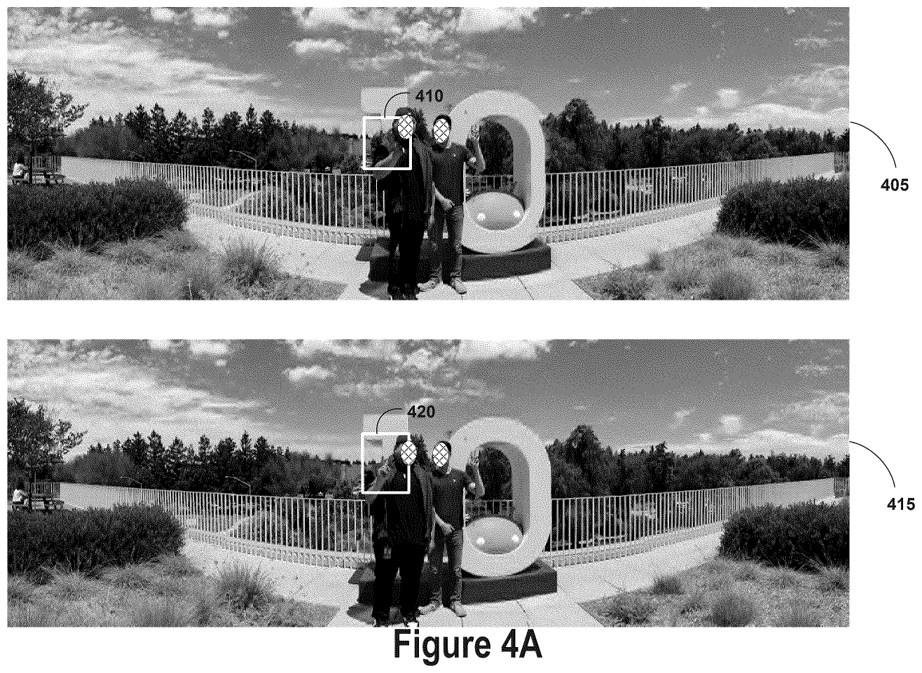

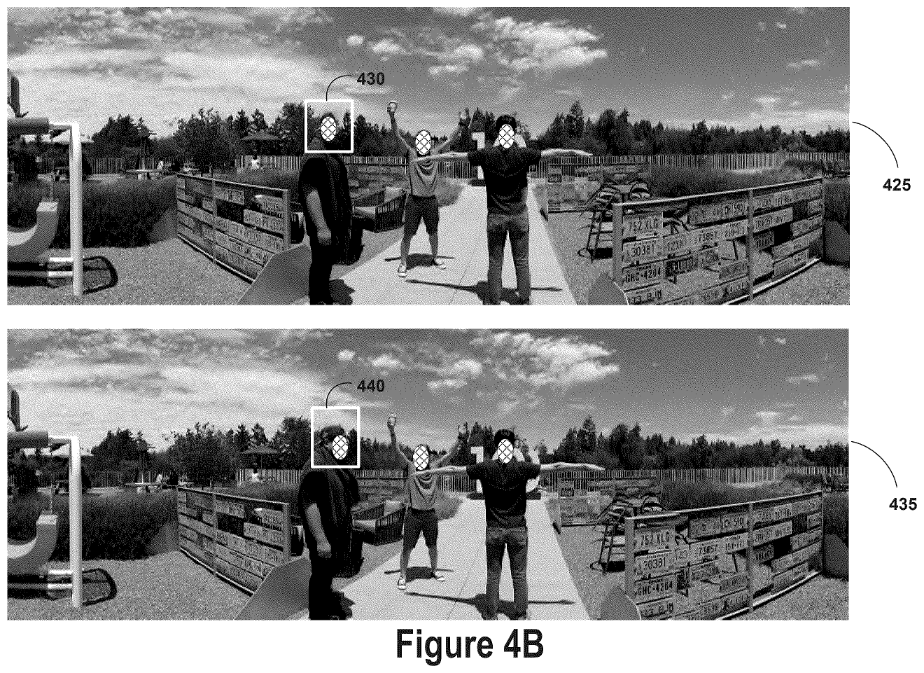

FIG. 4A illustrates a panorama image with and without subject-based adjustments, in accordance with example embodiments. Image 405 illustrates how an approach to generating a panorama image without subject-based adjustments can lead to discrepancies and/or distortions. For example, bounding box 410 shows how the hand of the individual to the left is distorted during a stitching process due to erroneous seam selection. For example, there is a portion of the right hand indicating a “V” sign that appears disjointed from the remainder of the hand. In some embodiments, the determining of the at least one seam involves preserving at least one object of interest of the one or more objects of interest in its entirety. Image 415 illustrates how an approach to generating a panorama image with subject-based adjustments can eliminate and/or reduce discrepancies and/or distortions. For example, bounding box 420 shows that the distortions visible in box 410 are eliminated.

FIG. 4B illustrates another panorama image with and without subject-based adjustments, in accordance with example embodiments. Image 425 illustrates how an approach to generating a panorama image without subject-based adjustments can lead to discrepancies and/or distortions. For example, bounding box 430 shows how the head of the individual to the left is distorted (e.g., due to a movement of the head during panorama capture) during a stitching process due to erroneous seam selection. In some embodiments, the determining of the at least one seam involves preserving at least one object of interest of the one or more objects of interest in its entirety. Image 435 illustrates how an approach to generating a panorama image with subject-based adjustments can eliminate and/or reduce discrepancies and/or distortions. For example, bounding box 440 shows that the distortions visible in box 430 are eliminated.

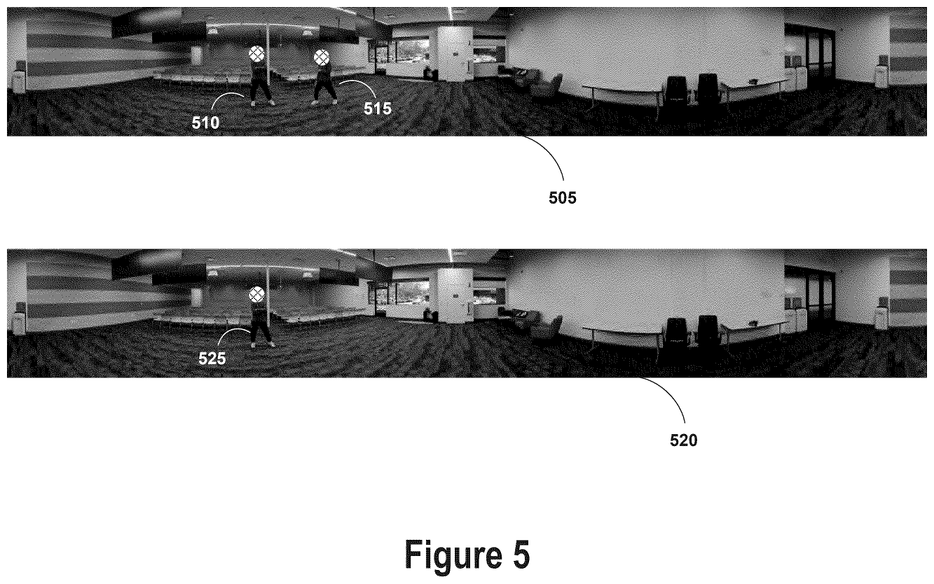

FIG. 5 illustrates a panorama image with and without subject-based adjustments, in accordance with example embodiments. Image 505 illustrates how an approach to generating a panorama image without subject-based adjustments can lead to discrepancies and/or distortions. For example, the same individual may appear twice as first object 510 and second object 515. This may occur, when the individual is moving and the plurality of frames capture the individual in different poses. Image 520 illustrates how an approach to generating a panorama image with subject-based adjustments can eliminate and/or reduce discrepancies and/or distortions. For example, the individual appears once as object 525, showing that the distortions visible in image 505 are eliminated. In some embodiments, the saliency heat map may be tracked from frame to frame to identify that first object 510 and second object 515 correspond to the same individual. Accordingly, the seam selection may be performed to capture the individual once in the panorama image (e.g., by selecting a seam that maintains the heat map corresponding to a larger weight or saliency score).

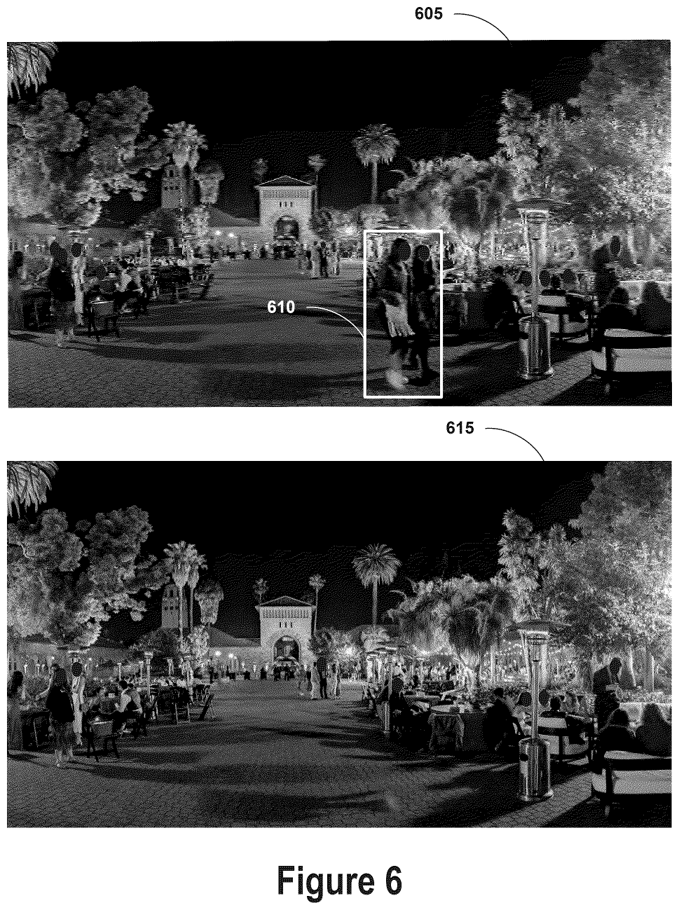

FIG. 6 illustrates a panorama image with and without subject-based adjustments, in accordance with example embodiments. Image 605 illustrates how an approach to generating a panorama image without subject-based adjustments can lead to discrepancies and/or distortions. For example, bounding box 610 includes two individuals in the foreground of image 605. As illustrated, some portions of the individual bodies are blurred or out of focus. Such motion artifacts may appear due to movement of the subjects.

In some embodiments, a respective weight associated with at least one object of interest of the one or more objects of interest may be below a threshold confidence level. The determining of the at least one seam may cause the at least one object of interest to not appear in the panorama image. For example, a saliency heat map associated with image 605 (not shown) is likely to indicate that the objects of interest in bounding box 610 are associated with a low saliency score. Image 615 illustrates how an approach to generating a panorama image with subject-based adjustments can eliminate and/or reduce discrepancies and/or distortions. For example, the individuals appearing in bounding box 610 are deemed to be of less significance, based on the low saliency scores. Accordingly, the individuals no longer appear in image 615.

Some embodiments involve identifying an overlapping region for the at least one pair of successive image frames. The determining of the at least one seam may involve determining a plurality of candidate seams within the overlapping region, associating respective seam scores with the plurality of candidate seams, and selecting the at least one seam from the plurality of candidate seams based on the respective seam scores. For example, different candidate seams may be associated with respective seam scores indicative of a quality of the seam for purposes of panorama generation. The at least one seam may be selected to be the best candidate scam (e.g., the candidate seam with an optimized seam score).

Some embodiments involve determining a plurality of first image tiles for a first portion of a first image frame of the at least one pair of successive image frames, wherein the first portion corresponds to the overlapping region. For example, an overlapping region may be identified for two successive image frames. Accordingly, the portion of the overlapping region in the left image frame of the two successive image frames may be divided into plurality of first image tiles. A tile, as used herein, is generally considered to be larger than an individual pixel. In some embodiments, the tiling may involve square or rectangular tiles of the same or different sizes. However, any type of tiling of a planar surface may be used.

Such embodiments also involve determining, for each first image tile of the plurality of first image tiles, a respective second image tile for a second portion of a second image frame of the at least one pair of successive image frames, wherein the second portion corresponds to the overlapping region. For example, the portion of the overlapping region in the right image frame of the two successive image frames may be divided into plurality of second image tiles. Generally, the same tiling is applied to the left and right images as the overlapping region is common.

Such embodiments further involve determining, for each pair comprising the first image tile and the respective second image tile, a respective alignment score indicative of a degree of alignment of the first image tile with the respective second image tile. For example, various measures of similarity may be used to compare the respective image tiles between the left and right image frames. A higher degree of similarity corresponds to a lower alignment score for a tile, and a lower degree of similarity corresponds to a higher alignment score for a tile. For example, the alignment scores may range from 0 to 1, with 0 indicating high degree of similarity and 1 indicating a low degree of similarity.

A seam score for a candidate seam may be based on an aggregate of alignment scores for image tiles traversed by the candidate seam. For example, for each candidate seam in the overlapping region may pass through the tiles. Accordingly, a seam score for the candidate seam may be determined by aggregating the alignment scores for the respective tiles. In some embodiments, the aggregating may include computing a sum of the alignment scores for the tiles traversed by the candidate seam. Accordingly, one strategy to determine that at least one seam may be to choose the candidate seam associated with a lowest seam score (indicating that the candidate seam traverses tiles that are maximally aligned).

For example, a first candidate seam may traverse five tiles that have alignment scores 0.3, 0.25, 0.2, 0.25, and 0.3. A first seam score for the first candidate seam may be determined as a sum of the alignment scores to be 1.3. Also, for example, a second candidate seam may traverse eight tiles that have alignment scores 0.15, 0.10, 0.12, 0.11, 0.2, 0.3, 0.15, and 0.1. A second seam score for the second candidate seam may be determined as a sum of the alignment scores to be 1.23. Accordingly, the second candidate seam may be selected as the at least one seam. Generally, the higher the seam score, the higher the “path resistance” for a seam, and the strategy may be to select a path of least resistance.

A tile based approach to seam selection and stitching (as opposed to a pixel-based approach) can be computationally efficient, especially in resource constrained environments, such as mobile devices.

### Example Tonemapping Methods

As image stitching is processed in a linear image domain, the stitched image has to feed into a high dynamic range (HDR) or enhanced HDR finish pipeline to convert the linear image to SDR image, i.e., a tonemapped image. However, it may not be feasible to simply apply a tone mapping setting from one of the stitching images.

One approach may be to rerun the auto exposure (AE) logic on the final stitched linear image to obtain the new tone mapping parameters for the local tonemapping (LTM) in the finish pipeline. However, the input to the AE is a 10 bit Bayer image (before align and/or merge is performed), that has lower image quality. There are a few differences between the Bayer image and the linear image. For example, there may be differences in image intensity and brightness. The linear image may generally be 16 bit, and the Bayer image may be 10 bit. Also, for example, there may be differences in noise distribution in the images. For example, the linear image may be chroma denoised. As another example, there may be differences in the white level and the black level. As another example, different gains may be applied. For example, an automatic white balancing (AWB) may have been applied to the linear image. Some approaches may involve reconverting the linear image to the Bayer format, and restoring the black level.

In some embodiments, the generating of the panorama image involves applying local tonemapping based on total exposure times (TET) associated with the at least one pair of successive image frames. For example, the long/short TET of the individual shots may be fused together and a single set of parameters may be determined for applying LTM. The following algorithm illustrates the process:

Given N shots, and each shot has its own LongTETᵢ and ShortTETᵢ, where
i ∈ {0, N − 1}
FinalShortestTET := min(ShortTETᵢ)
Scaleᵢ := FinalShortestTET / ShortTETᵢ
UpdatedLongTETᵢ := Scaleᵢ × LongTETᵢ
FinalLongTET := max(UpdatedLongTETᵢ)

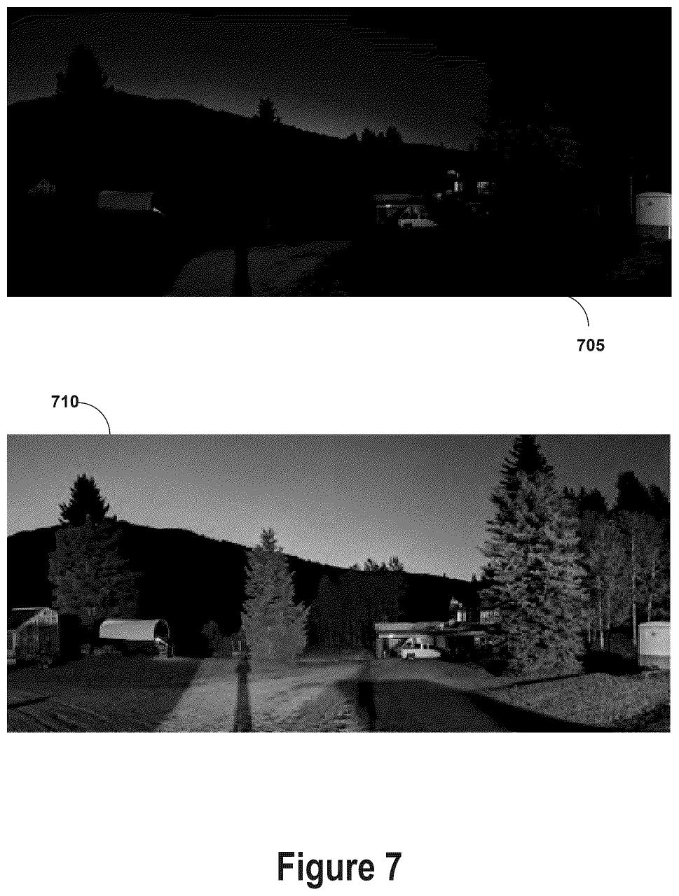

FIG. 7 illustrates a comparison between rerunning the auto exposure (AE) logic and using a tonemapping algorithm, in accordance with example embodiments. Image 705 indicates a darker image that is not matched to the default image setting. This may be caused due to an inaccurate reversing process (i.e., converting linear image back to Bayer format). Image 710 illustrates the result of applying the tonemapping algorithm.

### Example Projection Methods

Some embodiments involve applying a cropped projection to the at least one pair of successive image frames. In some embodiments, the cropped projection includes one or more of a cylindrical projection, a spherical projection, a rectilinear projection, or a sinusoidal projection.

Spherical projection, also referred to as equirectangular projection, maps the latitude and longitude coordinates of a spherical globe directly onto horizontal and vertical coordinates of a grid, where the maximum width is twice of the max height. Horizontal stretching therefore increases farther from the poles, with the north and south poles being stretched across the entire upper and lower edges of the flattened grid. Spherical projection generally maintains more accurate relative sizes of objects from most view angles and serves well for tilted captures. Some approaches may be based on preferring the object size accuracy and the least distortion over the pixel amounts.

Cylindrical projection is similar to equirectangular, except that it also vertically stretches objects as they get closer to the north and south poles, with infinite vertical stretching occurring at the poles (therefore no horizontal line is shown at the top and bottom of a flattened grid). This property may make cylindrical projections unsuitable for images with a very large vertical angle of view.

Rectilinear projection maps all straight lines in three-dimensional space to straight lines on a flattened two-dimensional grid. However, the main disadvantage is that the projection may significantly exaggerate perspective as the view angle increases, leading to objects appearing skewed at the edges of the frame.

Sinusoidal projection provides accurate area and distance at every parallel and at the central meridian. The equator and the central meridian are the most accurate parts of the map with little to no distortion. The further away from the equator and the central meridian, the greater the distortion.

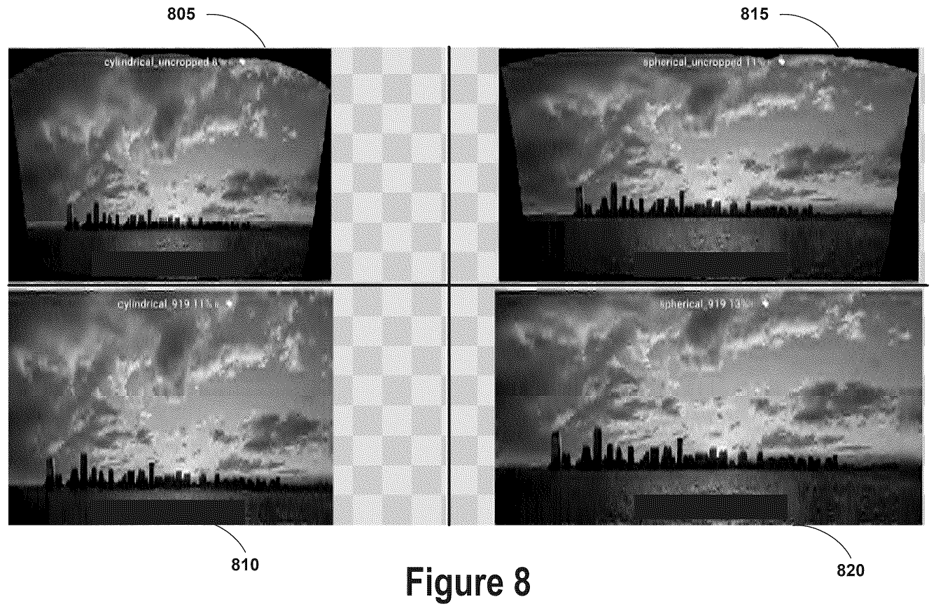

FIG. 8 illustrates example projections, in accordance with example embodiments. Image 805 illustrates an uncropped cylindrical projection, and image 810 illustrates a cropped cylindrical projection. Image 815 illustrates an uncropped spherical projection, and image 820 illustrates a cropped spherical projection.

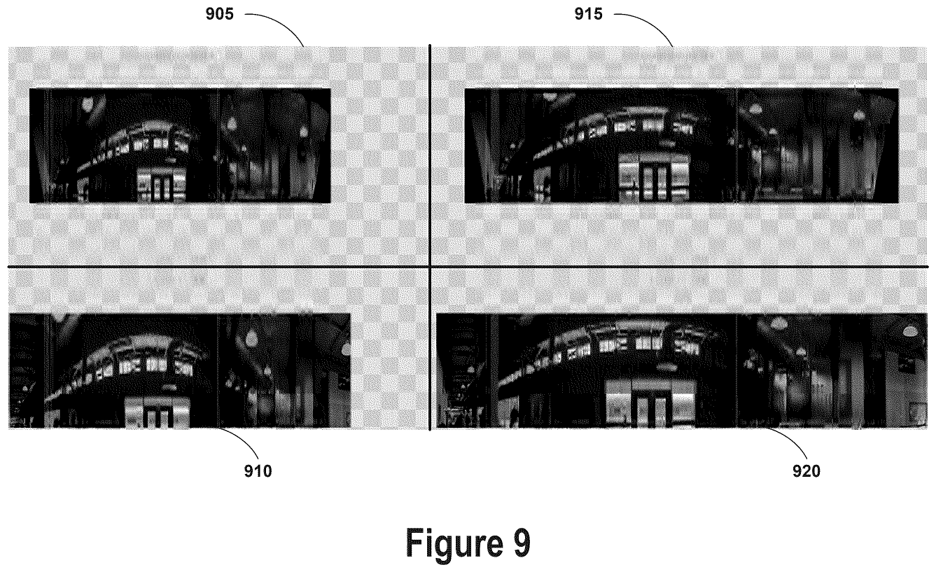

FIG. 9 illustrates example projections, in accordance with example embodiments. Image 905 illustrates an uncropped cylindrical projection, and image 910 illustrates a cropped cylindrical projection. Image 915 illustrates an uncropped spherical projection, and image 920 illustrates a cropped spherical projection.

### Example Methods for Image Alignment

Some embodiments involve aligning the at least one pair of successive image frames based on a sensor-based alignment, an image feature based alignment, or a tile based alignment. For example, a sensor fusion result (e.g., using gyro and accelerometer) may be used to project and align the successive image frames. This can be based on an orientation matrix generated by the camera application.

In some embodiments, a standard feature matching process may be applied to the successive image frames, optionally with forward and/or backward checks. However, such an approach may be challenging when the image lacks a sufficient number of detectable features, and/or there are no good features available for feature matching. As some cameras support single horizontal directional capturing, the corresponding feature between the images may be determined around the same vertical offset.

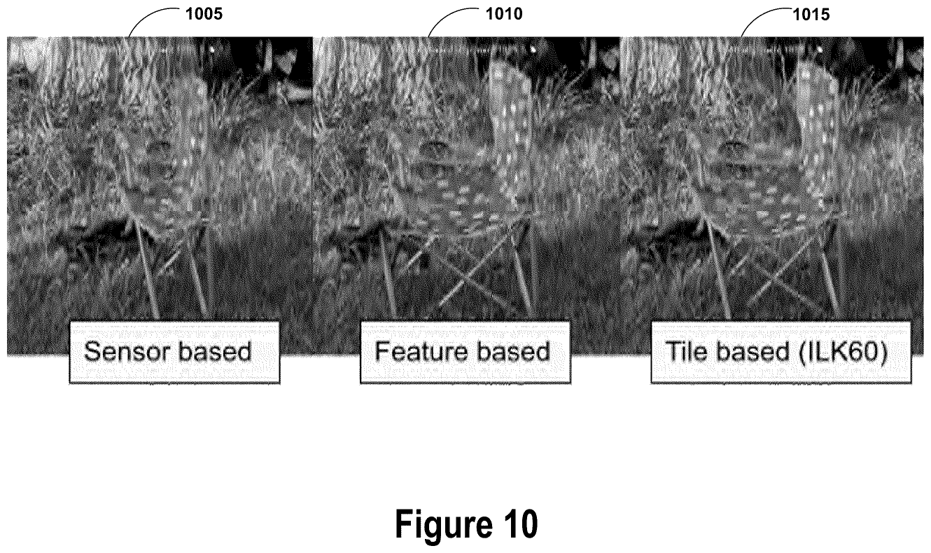

FIG. 10 illustrates example alignments, in accordance with example embodiments. Image 1005 illustrates a sensor based approach, image 1010 illustrates a feature based approach, and image 1015 illustrates a tile based approach. As illustrated in image 1010 and 1015, both the image feature based approach and the tile based alignment show good improvement in many real cases. Image 1005 shows the chair in the foreground to be distorted.

In some embodiments, a tile based feature matching process may be applied. Some advantages to this approach are that a presence of good features is not necessary, as long as there are some visible textures (e.g., non repeated). The approach can also be more resilient to a brightness change, as the brightness normalization can be performed internally, as described herein.

In some embodiments, after a motion flow map is retrieved from the camera application, a filter algorithm may be applied to aggregate the meaningful tiles and generate a global motion vector for the alignment. For example, the image feature based approach or the tile based approach may be used to distill a motion result and generate a global translation vector to perform the image alignment between the successive image frames.

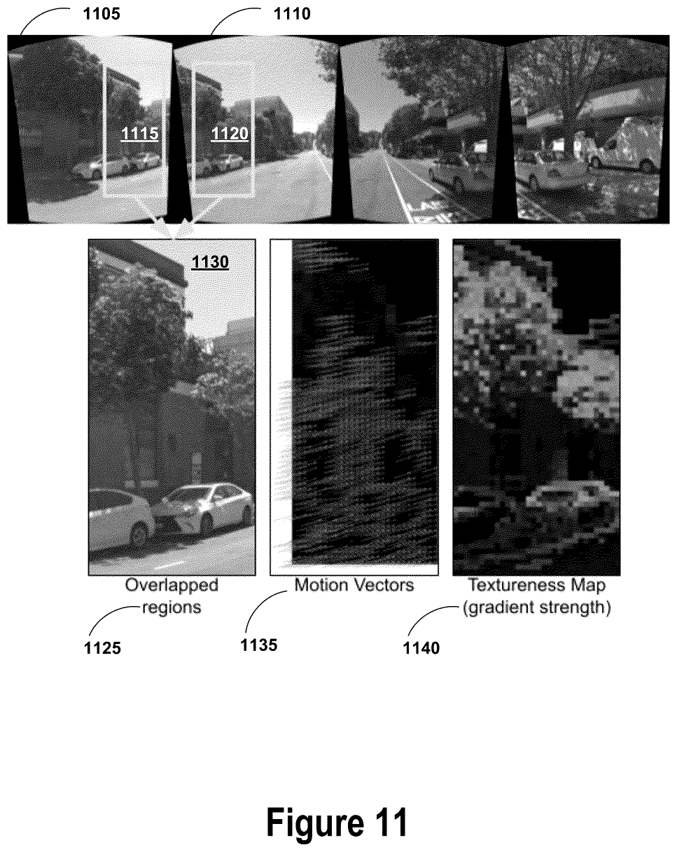

FIG. 11 illustrates example tile-based alignment, in accordance with example embodiments. Image 1105 and image 1110 are successive image frames. An overlapping region in each image is shown in respective boxes 1115 and 1120. For example, the overlapped region between the successive image frames may be estimated. In some embodiments, the overlapped region may be maximized by a “greedy” approach. Image 1125 is an expanded view of the overlapping region.

Some embodiments involve determining overlapping regions for the plurality of image frames. Such embodiments involve determining optical flow fields for the overlapping regions. Such embodiments also involve aligning the optical flow fields to generate the panorama image. For example, an optical flow field of the overlapping region may be estimated. Image 1135 illustrates an optical flow field comprising motion vectors for the overlapping region. A textureness map may be determined, as illustrated in image 1140. For a given textureness threshold, the motion vectors that correspond to a low textureness tile may be filtered out. In some embodiments, a uniformness of the motion vectors may be estimated, to determine whether the motion vectors are not exhibiting approximately similar motion directions. The motion vector may be sorted independently in the x and y directions, and a median value of each direction may be determined to generate a median vector. Image alignment may involve applying the median vector to offset the image in the rendering path.

### Example Methods for Shading Adjustments

Lens shading can be a common artifact in an image, especially in a low light environment, where the brightness ratio between the image center and the boundary is larger, as fewer photons arrive at the sensor's boundary. This may result in shadows. As used herein, the “shadows” or “shadow areas” of an image (or sequence of images) should be understood to include pixels or areas in an image (or across a sequence of images) that are the darkest. In practice, a pixel or area(s) in the image frame having a brightness level below a predetermined threshold may be identified as a shadow area. Of course, other methods for detecting a darker area that qualifies as a shadow area are also possible. Some embodiments involve determining, based on a lens position, a shading adjustment for a given image frame of the at least one pair of successive image frames. Generally, different lens positions correspond to different shading strengths.

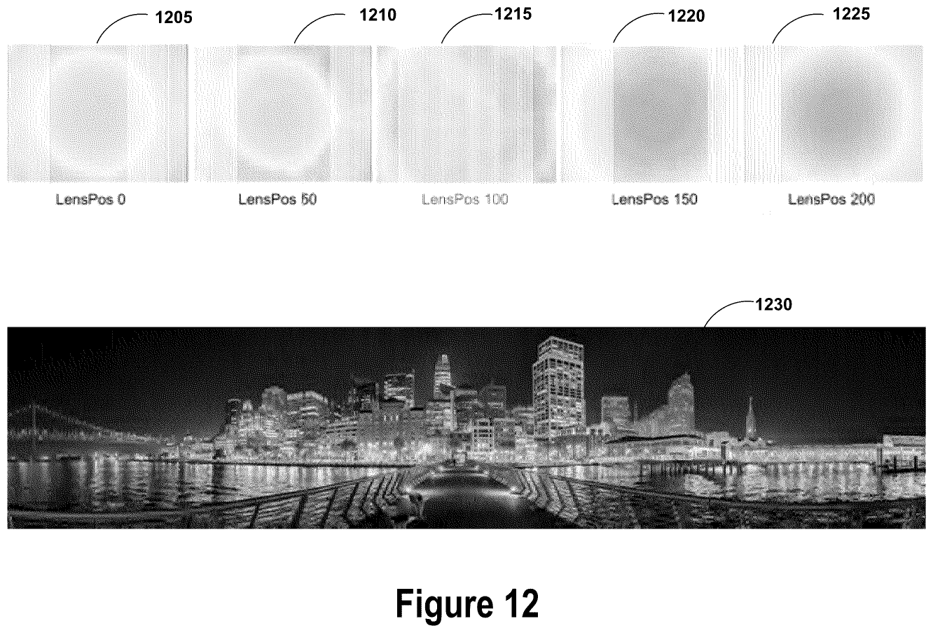

FIG. 12 illustrates adaptive shading compensation, in accordance with example embodiments. Images 1205, 1210, 1215, 1220, and 1225 correspond respectively to lens positions 0, 50, 100, 150, and 200. In some embodiments, a calibration may be performed in a factory to determine the shading adjustment for each of these lens positions. A customized shading table may be determined for a panorama mode in a camera. In some embodiments, the corner gain may be boosted to 96%, and in combination with an auto-focus (AF) compensation, the shading issue may be mitigated in a generated panorama image. Image 1230 illustrates a generated panorama image of a night scene without the uneven brightness issues.

In some embodiments, the determining of the shading adjustment involves retrieving, from stored memory, one or more predetermined shading adjustments associated with one or more lens positions. The determining of the shading adjustment involves interpolating the one or more predetermined shading adjustments based on a value of the lens position with respect to the one or more lens positions. For example, an adaptive shading compensation table may be stored in memory (e.g., as a look-up table (LuT)). The value of the lens position, L, may be determined for a given image frame. The value L, may be compared to the one or more known lens positions, such as, 0, 50, 100, 150, and 200. Each of these one or more known lens positions correspond to predetermined shading adjustments, based on the factory calibration process. Accordingly, based on the value of L with respect to 0, 50, 100, 150, and 200, the corresponding shading adjustment may be determined using interpolation techniques. The interpolation techniques may involve linear, quadratic, or other higher order polynomial or non-polynomial interpolations.

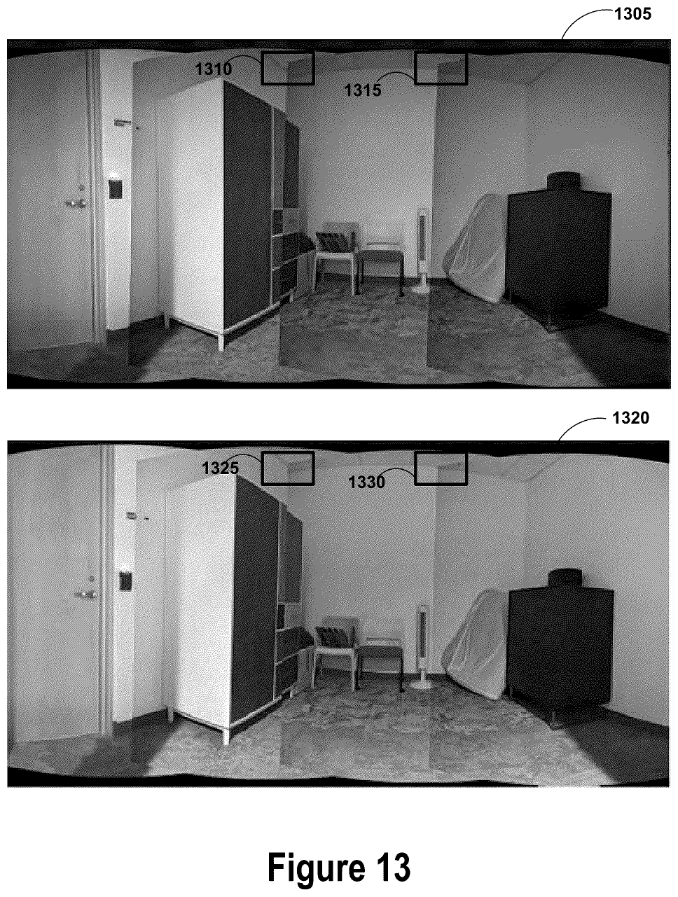

FIG. 13 illustrates an example of a shading compensation, in accordance with example embodiments. Image 1305 depicts a panorama without a shading adjustment. As indicated by portions 1310 and 1315, the corners appear shaded. Image 1320 depicts a panorama with a shading adjustment. As indicated by portion 1325 (corresponding to portion 1310 of image 1305), and portion 1315 (corresponding to portion 1315 of image 1305), the corners appear to be evenly lit.

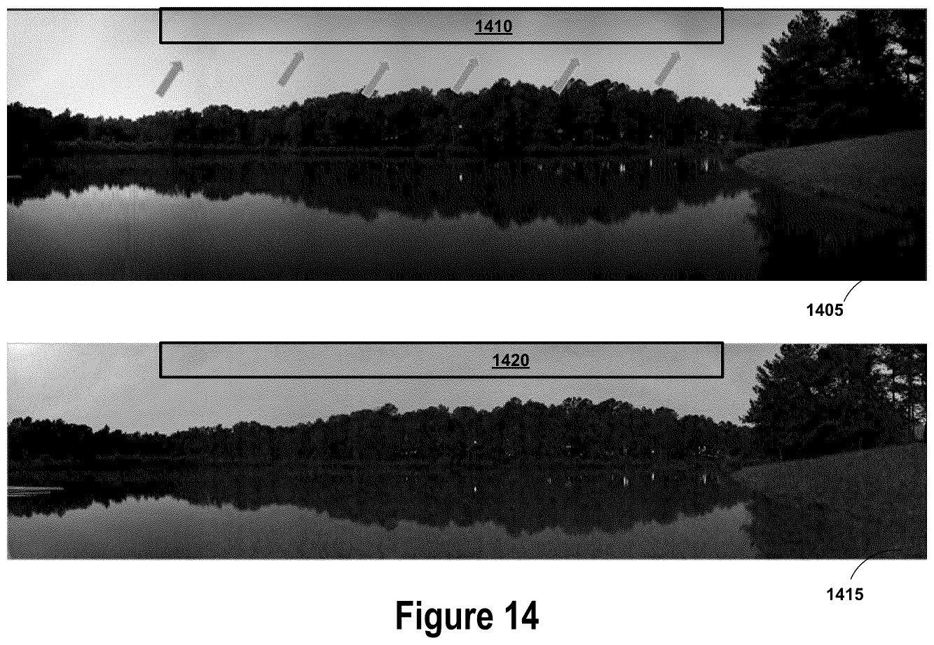

FIG. 14 illustrates another example of a shading compensation, in accordance with example embodiments. Image 1405 is a panorama without a shading adjustment. As indicated by portion 1410, banding issues appear. Image 1415 depicts a panorama with a shading adjustment. As indicated by portion 1420 (corresponding to portion 1410 of image 1405), the shading issue is resolved.

### Example Cropping Methods

Image cropping involves removing invalid pixels to generate a final panorama. The invalid pixels may appear due to several factors, including image stitching, image alignment, image warping, projections, tone mapping, and so forth. In some embodiments, the generating of the panorama image involves cropping the at least one pair of successive image frames to maintain a threshold image height. For example, as a panorama may become longer, the vertical height may get correspondingly reduced. Accordingly, maintaining a minimum vertical height may be a priority. In some embodiments, the generating of the panorama image involves cropping the at least one pair of successive image frames to preserve a total pixel count. For example, maximizing a number of valid pixels in the final panorama may be prioritized. Also, for example, destructive cropping (e.g., removal of interesting portions of an image) may be avoided.

There may be situations where images that are captured with a tilted angle and/or visible shifts perpendicular to the capture direction appear. In such situations, it is desirable, and challenging, to balance aggressive cropping and non-destructive cropping. For example, in some extreme cases, a large number of valid pixels may be cropped, and this can be undesirable for image quality purposes. In some embodiments, a certain amount of invalid boundary pixels may be allowed to balance aggressive cropping and non-destructive cropping.

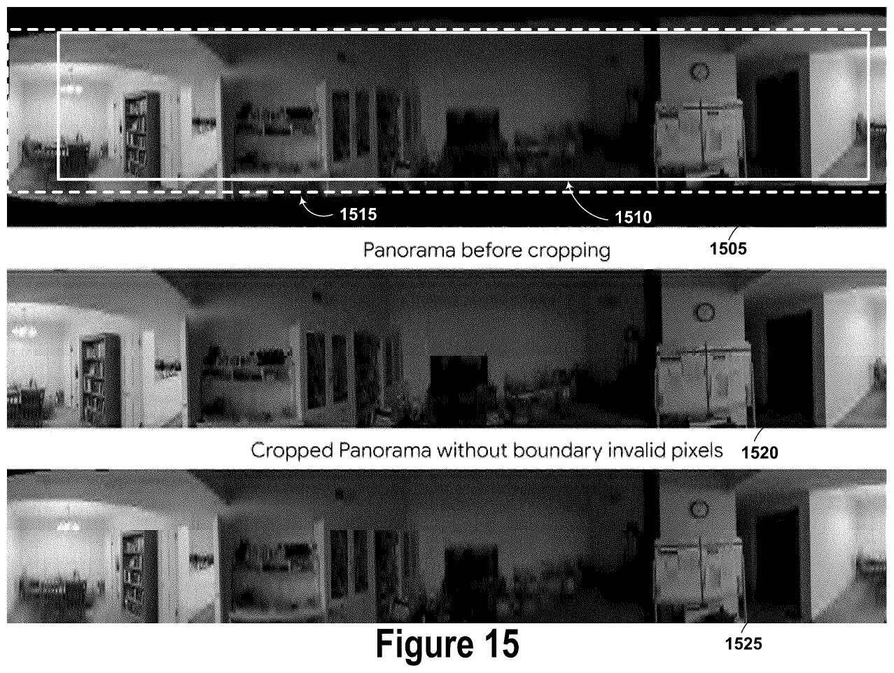

FIG. 15 illustrates an example image cropping, in accordance with example embodiments. Image 1505 illustrates a panorama prior to cropping. As indicated by the darker portion surrounding image 1505, there are a large number of invalid pixels. A first cropping box 1510 is shown with a solid boundary. This corresponds to a situation based on an aggressive cropping strategy that removes the large number of invalid pixels, but also removes a large portion of valid pixels. The cropped panorama based on the first cropping box 1510 is shown in image 1520.

A second cropping box 1515 is shown with a dashed boundary. This corresponds to a situation based on a less aggressive and/or pixel-optimized cropping strategy that removes a substantial number of invalid pixels, but also keeps a portion of invalid pixels. One strategy may be to apply a “greedy” approach to keep as many valid pixels as possible. The cropped panorama based on the second cropping box 1515 is shown in image 1525.

### Example Methods for Brightness Normalizations

Some embodiments involve associating the at least one pair of successive image frames with respective brightness levels. Such embodiments involve adjusting a brightness level for the panorama image based on the respective brightness levels. As linear image data is enabled, and with accurate AE setting and/or metadata, the brightness may be normalized in the linear domain.

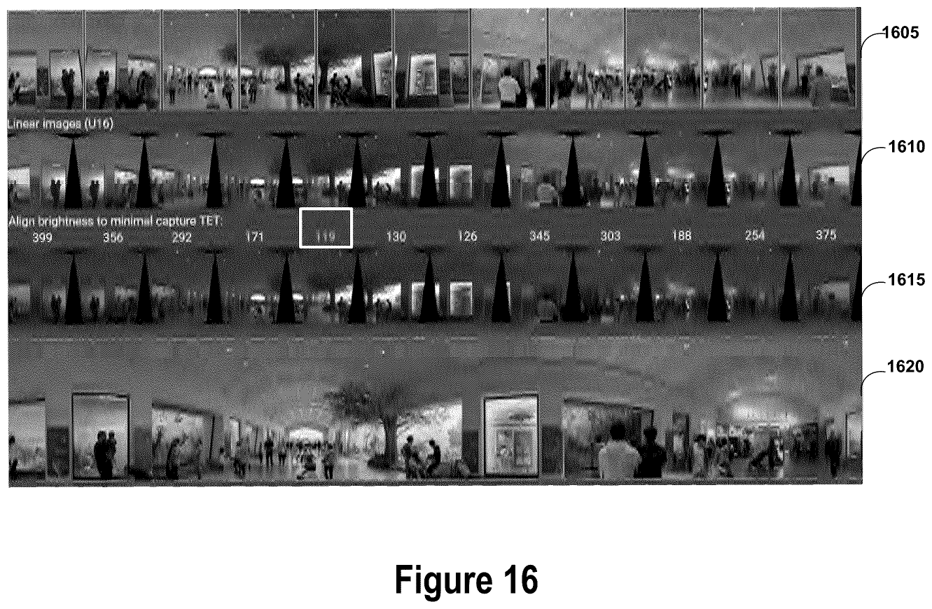

FIG. 16 illustrates an example image brightness adjustment, in accordance with example embodiments. Image 1605 illustrates a plurality of image frames that are linear images. Image 1610 indicates how each image frame is associated with a respective brightness level. For example, the plurality of image frames correspond to brightness levels of 399, 356, 292, 171, 119, 130, 126, 345, 303, 188, 254, and 375. As shown, the different brightness levels can cause an overall brightness level of the generated panorama to vary widely, leading to a poor user experience, and low image quality. In some embodiments, the lowest brightness value, such as, 119 (indicated in image 1610 by a solid box) may be used as a standard for adjusting the brightness levels for all the image frames. This is illustrated in image 1615 where the brightness level for the plurality of image frames is set at 119. Image 1620 illustrates a result of applying the brightness adjustment to the panorama image, resulting in a uniform brightness for the panorama image.

Moving subjects in the plurality of image frames has been a persistent technical hurdle for generating a panorama. Moving subjects may complicate alignment, introduce ghosting artifacts, and/or compromise user experience.

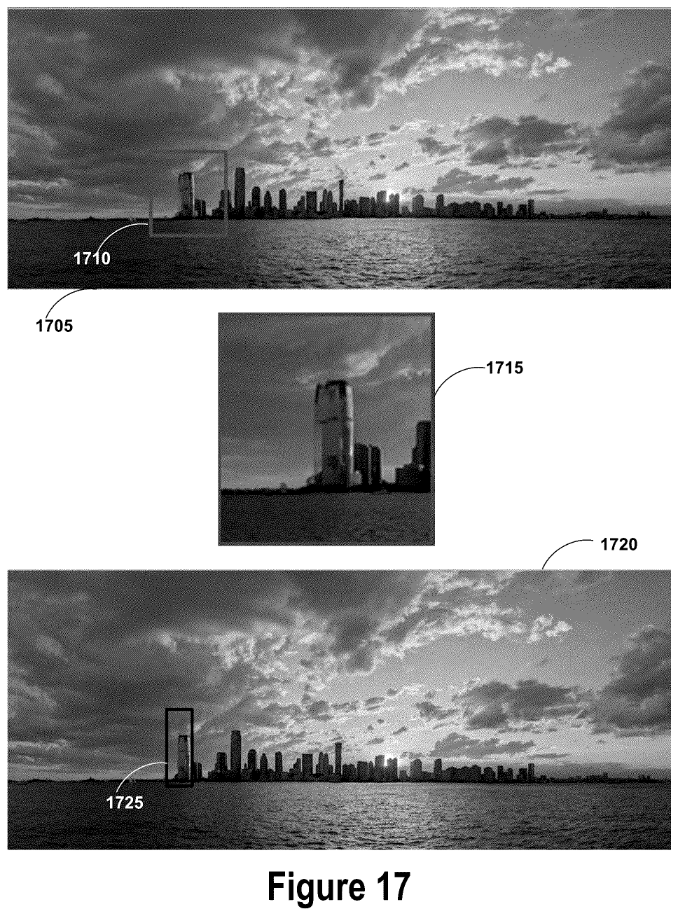

FIG. 17 illustrates an example removal of a ghosting artifact, in accordance with example embodiments. Image 1705 illustrates a panorama where ghosting artifacts appear in a portion of the image, indicated by box 1710. Image 1715 is an enlarged view of the portion of the image within box 1710. Image 1720 is a panorama generated based on image alignment, seam carving, and adaptive blending. As indicated by box 1725, the ghosting artifacts have been removed.

Various aspects of panorama generation are described herein. The stitching engine may receive a sequence of linear enhanced HDR image frames once the image capture begins, processes them in parallel, and generates the final gamma panorama image as output. The brightness of each image frame of the plurality of image frames may be adjusted to the first image frame. Each image frame may be warped using a customized projection solution. In some embodiments, an alignment based local warping may be applied to each pair of successive image frames to reduce and/or eliminate ghosting artifacts. Subject selection heatmaps may be generated by leveraging projection and subject detection. A seam calculation strategy may be applied between each pair of successive image frames by consolidating alignment, local warping, and subject selection. Also, for example, each image frame of the plurality of image frames may be rendered onto a final panorama canvas through adaptive blending. The brightness may be adaptively normalized across all the image frames, once the image capture is completed and the aforementioned processing for each image frame is complete. A cropping strategy may be applied by adopting the most pixel preserving strategy, along with maintaining an adaptive minimum height. Enhanced HDR Tone Mapping may be applied on the linear panorama to generate the final gamma panorama.

Some processing cannot be completed until all the image frames are captured. For example, brightness normalization, alignment between adjacent shots, blending, etc. are performed on all the image frames. Memory management may be optimized by pre-allocating the final panorama canvas with a fixed size. Also, for example, the brightness of each incoming image frame may be aligned to the first image frame while keeping track of the gains or losses. Each image frame may be rendered on the fly onto the final panorama canvas after the projection, alignment, subject selection and seam finding, instead of keeping a copy of each projected image frame. Subsequent to cropping, the panorama may be sent for HDR tonemapping.

### Example User Interfaces for Panorama Generation

Some embodiments involve providing an interactive user interface with virtual elements to guide a user in capturing the panorama image. The user interface may provide multi-modal suggestions to a user, including textual displays and speech guidance. Existing approaches to generating panorama images rely on the video functionality of the camera. The techniques described herein rely on capturing a plurality of images and stitching them together. Also, for example, Night Sight features are not available in existing approaches.

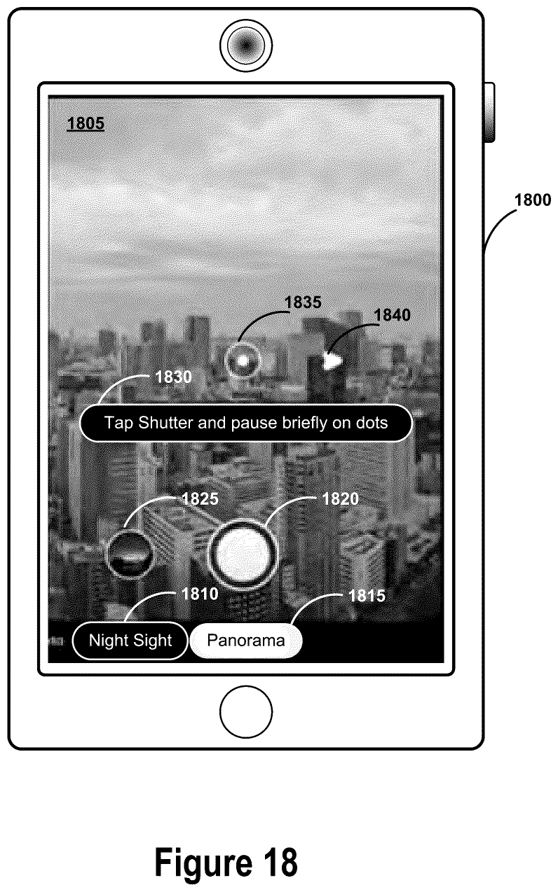

FIG. 18 illustrates an example first instance of a user interface for panorama generation, in accordance with example embodiments. Device 1800 may be configured to display a user interface. A first instance 1805 of the user interface may display a first user selectable mode for “Night Sight” mode 1810. User selection of the “Night Sight” mode 1810 causes device 1800 to apply image enhancements related to Night Sight features. In some embodiments, the “Night Sight” mode 1810 may cause a panorama to be captured and/or post-processed with capabilities to enhance images captured in low light scenarios. The first instance 1805 of the user interface may display a second user selectable mode for “Panorama” mode 1815. User selection of the “Panorama” mode 1815 causes device 1800 to apply features related to panorama capture and panorama generation. For example, user selection of the “Panorama” mode 1815 may cause device 1800 to initiate panorama guidance for the user that guides the user during panorama capture. Generally, a user may have an option to pre-select automatic “Night Sight” mode or “Panorama” mode. In these situations, the camera automatically switches to the appropriate mode when the conditions are right. For example, when the preview displays an image in the dark, the camera may automatically switch to “Night Sight” mode.

First instance 1805 of the user interface may display a shutter icon 1820, an image thumbnail icon 1825, and a first guidance 1830 indicating “Tap Shutter and pause briefly on checkpoints.” A first checkpoint 1835 may be displayed and a forward arrow 1840 indicating the direction of panning for panorama capture. The checkpoint serves as a guide but also functional to bringing HDR+ and Night Sight to panorama. The checkpoints also serve as a guide and way for users to take high resolution panoramas. Each checkpoint may have an associated task for the user to complete. Checkpoints are a significant component of the new panorama experience. With the design described herein, the photo capture pipeline may be used to obtain higher resolution panoramas. In order to do this, users align the reticle to the checkpoint for a higher resolution panorama.

In some embodiments, a section of the panorama may be generated when a particular task at a particular checkpoint is completed. In the event a user misses a checkpoint, and or overshoots it, the user may be guided back to complete a task at the checkpoint. Also, for example, a level indicator may indicate an amount of panorama completed.

Some embodiments may include a preview track (e.g., at the top of the user interface, on one side of the user interface, etc.) that keeps track of the panorama progress. The preview slides to capture and reveal the image. For example, a current preview may be displayed followed by a sequence of dots that indicate a future path for the user to follow. This can be part of a choreographed effort to make the experience follow the photo stitching experience. In some embodiments, at 220° or greater, the preview may be scaled down to reveal the full 360°. This can optimize for space and usage at less than 220° while also providing the full 360° for those who want the full panorama.

A reticle is a guiding virtual object that consists of a circle for users to align the checkpoint and the leveling indicator. This enables users to stay aligned during panorama generation. By staying level, users are able to stitch a more consistent panorama. The reticle serves as a proactive guide to the user.

The arrow 1840 can proactively guide users to their next checkpoint. In some existing panorama features, the arrow appears once users make a mistake. In some embodiments, the arrow points to the next circle and when the camera is panned to approach the next circle, the arrow may become smaller, scale down, and disappear as the next circle gets closer.

The night sight capture pipeline may be used to capture low light panoramas. The users may have to hold still on each dot/checkpoint because they are essentially capturing a Night Sight photo at each checkpoint. This means that the exposure will be longer.

As a user begins the panorama capture, the dot may be configured to grow inside the reticle (outlined circle) and then may complete the experience with a pulse (when the checkpoint and reticle are aligned). There may also be ques using haptics that inform the user that they have completed their task. Users may then move on to the next checkpoint following the arrow. For Night Sight Panorama, users may need to stay on the dots longer so that the device can apply the Night Sight technology.

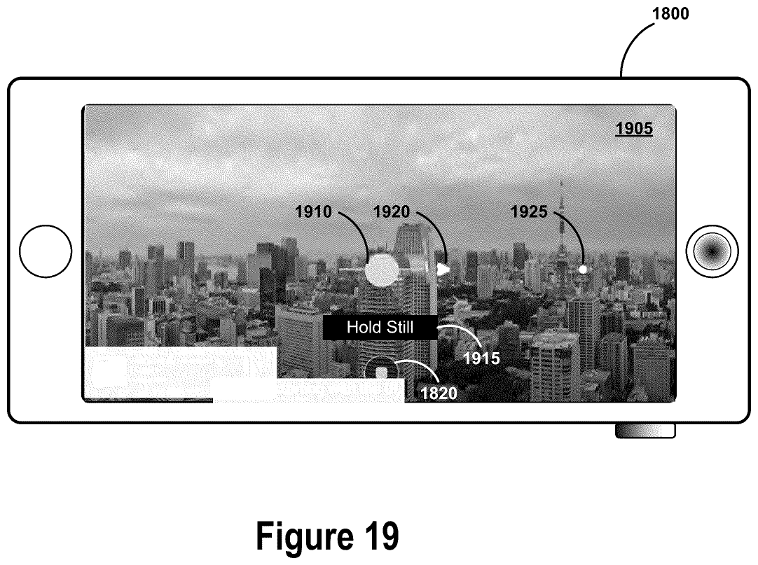

FIG. 19 illustrates an example second instance of a user interface for panorama generation, in accordance with example embodiments. Device 1800 may be configured to display a second instance 1905 of the user interface. As the user continues to capture the panorama by panning the camera and reaches the location in the scene indicated by first checkpoint 1835 (from FIG. 18), second instance 1905 of the user interface may display an indication (e.g., highlighted circle 1910) and provide a second guidance 1915 indicating the user to “Hold still.” After holding the camera still while pointing at first checkpoint 1835, the user may be guided by second arrow 1920 to pan toward the location in the scene indicated by second checkpoint 1925. Generally speaking, depending on factors such as scene characteristics, ambient lighting characteristics, length of the panorama, depth of field, locations of objects of interest and so forth, additional and/or alternate checkpoints may be provided. Also, for example the guidance checkpoints may not be linearly located, and the user may be directed to move device 1800 in different directions (e.g., vertical, horizontal, angular, etc.) and/or rotate device 1800.

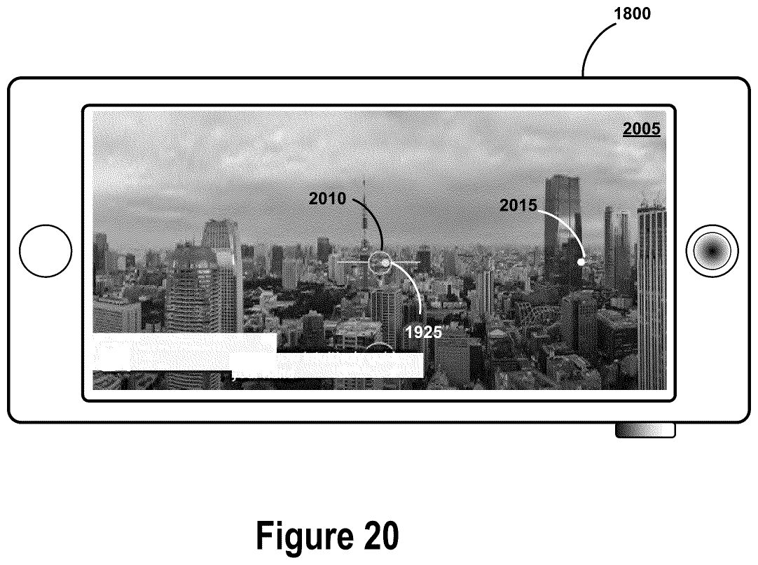

FIG. 20 illustrates an example third instance of a user interface for panorama generation, in accordance with example embodiments. Device 1800 may be configured to display a third instance 2005 of the user interface. As the user continues to capture the panorama by panning the camera toward the second checkpoint 1925, reticle 2010 indicates proximity to second checkpoint 1925. For example, when second checkpoint 1925 is at the center of reticle 2010, then reticle 2010 may be converted to a highlighted circle, such as highlighted circle 1910 of FIG. 19. Also, for example, a third checkpoint 2015 may be displayed to guide the user in panning the scene.

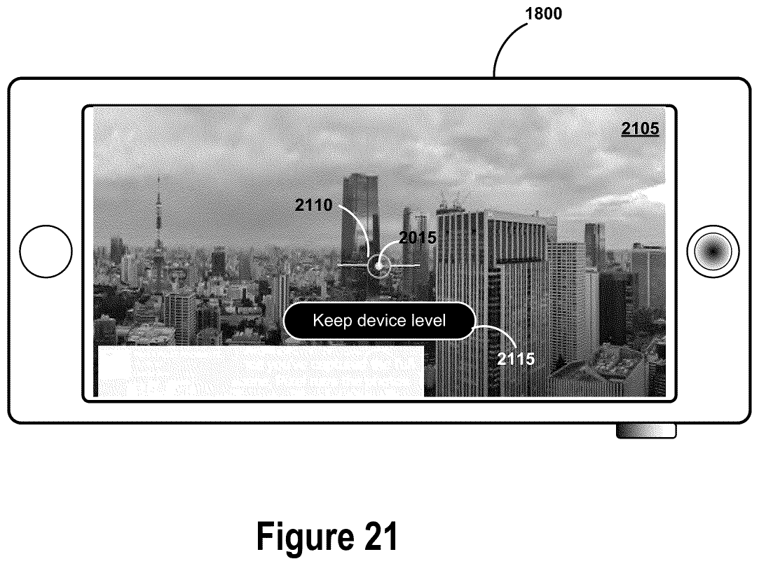

FIG. 21 illustrates an example fourth instance of a user interface for panorama generation, in accordance with example embodiments. Device 1800 may be configured to display a fourth instance 2105 of the user interface. As the user continues to capture the panorama by panning the camera toward the third checkpoint 2015, and the camera is pointed at the third checkpoint 2015, the reticle 2110 may appear to encircle the third checkpoint 2015. Also, for example, a third guidance 2115 indicating the user to “keep device level” may be displayed.

Additional and/or alternate guidance instructions may be displayed indicating the user to perform certain functions. In some embodiments, a timer may be displayed to guide the user in how long to maintain a certain position such as “hold still,” “continue to pan,” “keep device level,” and so forth. For example, the camera may use auto exposure (AE) settings to determine an amount of light to collect to capture image details.

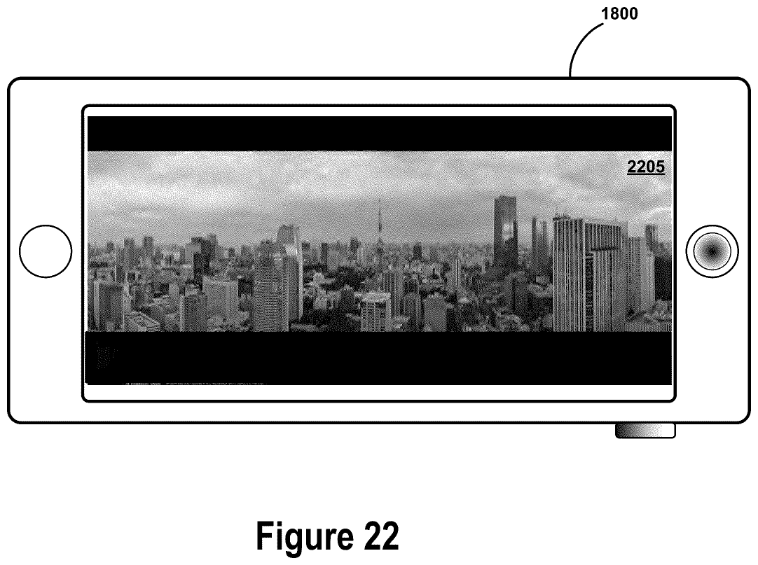

FIG. 22 illustrates an example fifth instance of a user interface for panorama generation, in accordance with example embodiments. Device 1800 may be configured to display a fifth instance 2205 of the user interface. Upon completion of the panorama capture process, device 1800 may use the techniques described herein to stitch together the plurality of image frames to generate the panorama image as displayed in the fifth instance 2205 of the user interface.

### Example Computing Device Architectures

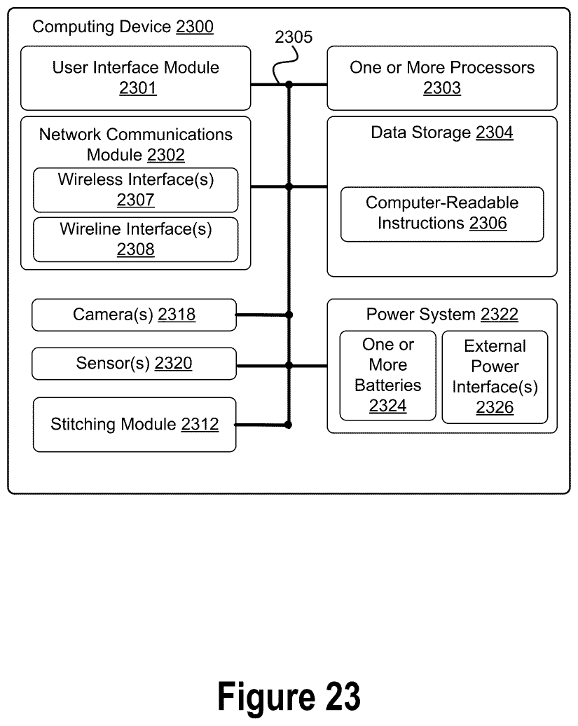

FIG. 23 is a block diagram of an example computing device 2300, in accordance with example embodiments. In particular, computing device 2300 shown in FIG. 23 can be configured to perform at least one function described herein, including method 1300.

Computing device 2300 may include a user interface module 2301, a network communications module 2302, one or more processors 2303, data storage 2304, one or more cameras 2318, one or more sensors 2320, and power system 2322, all of which may be linked together via a system bus, network, or other connection mechanism 2305.

User interface module 2301 can be operable to send data to and/or receive data from external user input/output devices. For example, user interface module 2301 can be configured to send and/or receive data to and/or from user input devices such as a touch screen, a computer mouse, a keyboard, a keypad, a touch pad, a trackball, a joystick, a voice recognition module, and/or other similar devices. User interface module 2301 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 2301 can also be configured to generate audible outputs, with devices such as a speaker, speaker jack, audio output port, audio output device, earphones, and/or other similar devices. User interface module 2301 can further be configured with one or more haptic devices that can generate haptic outputs, such as vibrations and/or other outputs detectable by touch and/or physical contact with computing device 2300. In some examples, user interface module 2301 can be used to provide a graphical user interface (GUI) for utilizing computing device 2300.

Network communications module 2302 can include one or more devices that provide one or more wireless interfaces 2307 and/or one or more wireline interfaces 2308 that are configurable to communicate via a network. Wireless interface(s) 2307 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 2308 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 2302 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 2303 can include one or more general purpose processors (e.g., central processing unit (CPU), etc.), and/or one or more special purpose processors (e.g., digital signal processors, tensor processing units (TPUs), graphics processing units (GPUs), application specific integrated circuits, etc.). One or more processors 2303 can be configured to execute computer-readable instructions 2306 that are contained in data storage 2304 and/or other instructions as described herein.

Data storage 2304 can include one or more non-transitory computer-readable storage media that can be read and/or accessed by at least one of one or more processors 2303. The one or more computer-readable storage media can include volatile and/or non-volatile storage components, such as optical, magnetic, organic or other memory or disc storage, which can be integrated in whole or in part with at least one of one or more processors 2303. In some examples, data storage 2304 can be implemented using a single physical device (e.g., one optical, magnetic, organic or other memory or disc storage unit), while in other examples, data storage 2304 can be implemented using two or more physical devices.

Data storage 2304 can include computer-readable instructions 2306 and perhaps additional data. In some examples, data storage 2304 can include storage required to perform at least part of the herein-described methods, scenarios, and techniques and/or at least part of the functionality of the herein-described devices and networks. In particular, computer-readable instructions 2306 can include instructions that, when executed by processor(s) 2303, enable computing device 2300 to provide for some or all of the functionality described herein.

In some embodiments, computer-readable instructions 2306 can include instructions that, when executed by processor(s) 2303, enable computing device 2300 to carry out operations. The operations may include receiving, by a computing device, a plurality of image frames. The operations may also include determining, by the computing device, one or more objects of interest within the plurality of image frames, wherein the determining is based on saliency heat maps indicative of the one or more objects of interest. The operations may additionally include determining at least one seam corresponding to at least one pair of successive image frames of the plurality of image frames, wherein the determining of the at least one seam is based on respective weights associated with the one or more objects of interest. The operations may also include stitching together, by the computing device and based on the at least one seam, the at least one pair of successive image frames to generate a panorama image.

The computing device 2300 may include a seam selection module (not shown) operable to select a seam based on saliency heat maps for objects of interest. The computing device 2300 may also include a stitching module 2312 operable to stitch together the adjacent image frames based on the selected seam. Using these two modules, the computing device 2300 could generate composite images, such as panoramic images, and then display those composite images to users. Stitching module 2312 may be a software application or subsystem within computing device 2300 that is operable to receive one or more image frames and responsively generate a single composite image, such as a panoramic image, from the one or more image frames. In some implementations, stitching module 2312 may receive the one or more image frames from camera(s) 2318. In other implementations, stitching module 2312 may receive the one or more image frames from another computing device via network communications module 2302.

In some examples, computing device 2300 can include one or more cameras 2318. Camera(s) 2318 can include one or more image capture devices, such as still and/or video cameras, equipped to capture light and record the captured light in one or more images; that is, camera(s) 2318 can generate image(s) of captured light. The one or more images can be one or more still images and/or one or more images utilized in video imagery. Camera(s) 2318 can capture light and/or electromagnetic radiation emitted as visible light, infrared radiation, ultraviolet light, and/or as one or more other frequencies of light. Camera(s) 2318 can include a wide camera, a tele camera, an ultrawide camera, and so forth. Also, for example, camera(s) 2318 can be front-facing or rear-facing cameras with reference to computing device 2300. Camera(s) 2318 can include camera components such as, but are not limited to, an aperture, shutter, recording surface (e.g., photographic film and/or an image sensor), lens, and/or shutter button. The camera components may be controlled at least in part by software executed by one or more processors 2303.

In some examples, camera(s) 2318 could be oriented at a specific rotation angle and may capture image frames at that rotation angle (also referred to herein as a lend position). In some implementations, the rotation angle is a horizontal angle. That is, the rotation angle may be the horizontal rotation of camera(s) 2318 from an initial pointing direction. In other implementations, the rotation angle is a vertical angle. That is, the rotation angle may be the vertical rotation of camera(s) 2318 from an initial pointing direction. In example embodiments, the initial pointing direction may correspond to the pointing direction of camera(s) 2318 as it captures a first image frame in a stream of image frames.

In some examples, computing device 2300 can include one or more sensors 2320. Sensors 2320 can be configured to measure conditions within computing device 2300 and/or conditions in an environment of computing device 2300 and provide data about these conditions. For example, sensors 2320 can include one or more of: (i) sensors for obtaining data about computing device 2300, such as, but not limited to, a thermometer for measuring a temperature of computing device 2300, a battery sensor for measuring power of one or more batteries of power system 2322, and/or other sensors measuring conditions of computing device 2300; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 2300, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 2300, such as, but not limited to, an infrared sensor, an optical sensor, a light sensor (e.g., an ambient light sensor), a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 2300, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 2320 are possible as well.

Power system 2322 can include one or more batteries 2324 and/or one or more external power interfaces 2326 for providing electrical power to computing device 2300. Each battery of the one or more batteries 2324 can, when electrically coupled to the computing device 2300, act as a source of stored electrical power for computing device 2300. One or more batteries 2324 of power system 2322 can be configured to be portable. Some or all of one or more batteries 2324 can be readily removable from computing device 2300. In other examples, some or all of one or more batteries 2324 can be internal to computing device 2300, and so may not be readily removable from computing device 2300. Some or all of one or more batteries 2324 can be rechargeable. For example, a rechargeable battery can be recharged via a wired connection between the battery and another power supply, such as by one or more power supplies that are external to computing device 2300 and connected to computing device 2300 via the one or more external power interfaces. In other examples, some or all of one or more batteries 2324 can be non-rechargeable batteries.

One or more external power interfaces 2326 of power system 2322 can include one or more wired-power interfaces, such as a USB cable and/or a power cord, that enable wired electrical power connections to one or more power supplies that are external to computing device 2300. One or more external power interfaces 2326 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 2326, computing device 2300 can draw electrical power from the external power source the established electrical power connection. In some examples, power system 2322 can include related sensors, such as battery sensors associated with the one or more batteries or other types of electrical power sensors.

One or more external power interfaces 2326 of power system 2322 can include one or more wired-power interfaces, such as a USB cable and/or a power cord, that enable wired electrical power connections to one or more power supplies that are external to computing device 2300. One or more external power interfaces 2326 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 2326, computing device 2300 can draw electrical power from the external power source the established electrical power connection. In some examples, power system 2322 can include related sensors, such as battery sensors associated with the one or more batteries or other types of electrical power sensors.

### Example Methods of Operation

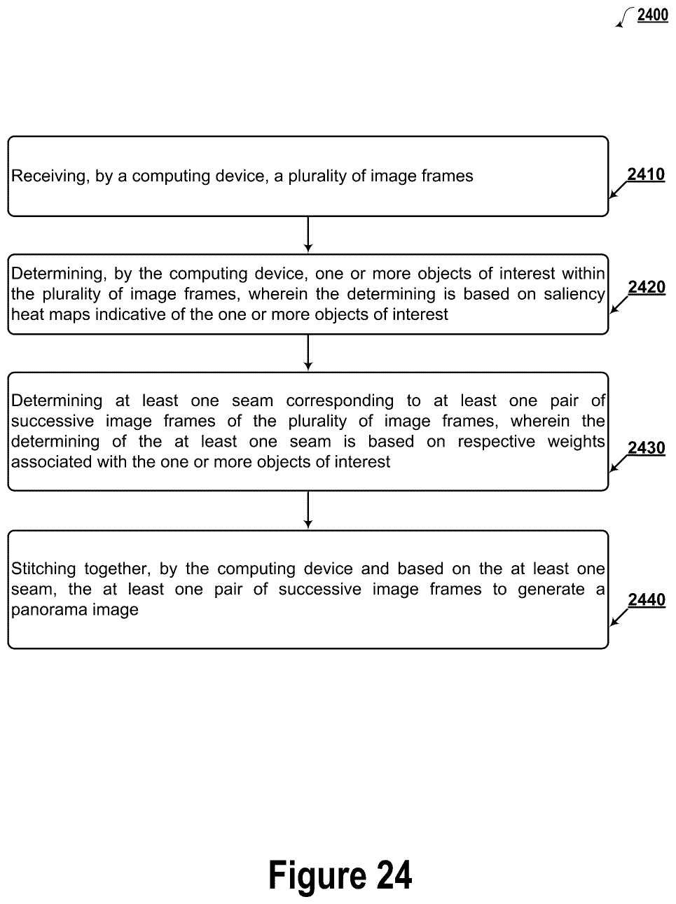

FIG. 24 is a flowchart of a method, in accordance with example embodiments. Method 2400 may include various blocks or steps. The blocks or steps may be carried out individually or in combination. The blocks or steps may be carried out in any order and/or in series or in parallel. Further, blocks or steps may be omitted or added to method 2400.

The blocks of method 2400 may be carried out by various elements of computing device 2300 as illustrated and described in reference to FIG. 23.

Block 2410 involves receiving, by a computing device, a plurality of image frames.

Block 2420 involves determining, by the computing device, one or more objects of interest within the plurality of image frames, wherein the determining is based on saliency heat maps indicative of the one or more objects of interest.

Block 2430 involves determining at least one seam corresponding to at least one pair of successive image frames of the plurality of image frames, wherein the determining of the at least one seam is based on respective weights associated with the one or more objects of interest.

Block 2440 involves stitching together, by the computing device and based on the at least one seam, the at least one pair of successive image frames to generate a panorama image.

Some embodiments involve identifying an overlapping region for the at least one pair of successive image frames. The determining of the at least one seam may involve determining a plurality of candidate seams within the overlapping region, associating respective seam scores with the plurality of candidate seams, and selecting the at least one seam from the plurality of candidate seams based on the respective seam scores.

Some embodiments involve determining a plurality of first image tiles for a first portion of a first image frame of the at least one pair of successive image frames, wherein the first portion corresponds to the overlapping region. Such embodiments also involve determining, for each first image tile of the plurality of first image tiles, a respective second image tile for a second portion of a second image frame of the at least one pair of successive image frames, wherein the second portion corresponds to the overlapping region. Such embodiments further involve determining, for each pair comprising the first image tile and the respective second image tile, a respective alignment score indicative of a degree of alignment of the first image tile with the respective second image tile. A scam score for a candidate scam may be based on an aggregate of alignment scores for image tiles traversed by the candidate scam.

In some embodiments, each of the one or more objects of interest may correspond to a human subject.

In some embodiments, the determining of the at least one seam involves adding a computational bias to seams that contain pixels from the one or more objects of interest.

In some embodiments, the determining of the at least one seam involves preserving at least one object of interest of the one or more objects of interest in its entirety.

In some embodiments, a respective weight associated with at least one object of interest of the one or more objects of interest may be below a threshold confidence level. The determining of the at least one seam may cause the at least one object of interest to not appear in the panorama image.

In some embodiments, the saliency heat maps indicative of the one or more objects of interest may indicate two overlapping objects of interest. The determining of the at least one seam involves preserving the two overlapping objects of interest in their entirety.

Some embodiments involve associating the at least one pair of successive image frames with respective brightness levels. Such embodiments involve adjusting a brightness level for the panorama image based on the respective brightness levels.

Some embodiments involve determining, based on a lens position, a shading adjustment for a given image frame of the at least one pair of successive image frames.

In some embodiments, the determining of the shading adjustment involves retrieving, from stored memory, one or more predetermined shading adjustments associated with one or more lens positions. The determining of the shading adjustment involves interpolating the one or more predetermined shading adjustments based on a value of the lens position with respect to the one or more lens positions.

In some embodiments, the generating of the panorama image involves applying local tonemapping based on total exposure times (TET) associated with the at least one pair of successive image frames.

Some embodiments involve applying a cropped projection to the at least one pair of successive image frames. In some embodiments, the cropped projection includes one or more of a cylindrical projection, a spherical projection, a rectilinear projection, or a sinusoidal projection.

Some embodiments involve aligning the at least one pair of successive image frames based on a sensor-based alignment, an image feature based alignment, or a tile based alignment.

In some embodiments, the generating of the panorama image involves cropping the at least one pair of successive image frames to maintain a threshold image height.

In some embodiments, the generating of the panorama image involves cropping the at least one pair of successive image frames to preserve a total pixel count.

Some embodiments involve determining overlapping regions for the plurality of image frames. Such embodiments involve determining optical flow fields for the overlapping regions. Such embodiments also involve aligning the optical flow fields to generate the panorama image.

In some embodiments, the plurality of image frames may be captured by a camera device in one continuous stream.

In some embodiments, the plurality of image frames may be captured using a front facing camera of a camera device.

In some embodiments, the computing device may be a mobile device.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

We claim:

1. A computer-implemented method comprising:
receiving, by a computing device, a plurality of image frames;
determining, by the computing device, one or more objects of interest within the plurality of image frames, wherein the determining is based on saliency heat maps indicative of the one or more objects of interest;
determining at least one seam corresponding to at least one pair of successive image frames of the plurality of image frames, wherein the determining of the at least one seam is based on respective weights associated with the one or more objects of interest; and
stitching together, by the computing device and based on the at least one seam, the at least one pair of successive image frames to generate a panorama image.

2. The computer-implemented method of claim 1, further comprising:
identifying an overlapping region for the at least one pair of successive image frames, and
wherein the determining of the at least one seam comprises:
determining a plurality of candidate seams within the overlapping region,
associating respective seam scores with the plurality of candidate seams, and
selecting the at least one seam from the plurality of candidate seams based on the respective seam scores.

3. The computer-implemented method of claim 2, further comprising:
determining a plurality of first image tiles for a first portion of a first image frame of the at least one pair of successive image frames, wherein the first portion corresponds to the overlapping region;
determining, for each first image tile of the plurality of first image tiles, a respective second image tile for a second portion of a second image frame of the at least one pair of successive image frames, wherein the second portion corresponds to the overlapping region;
determining, for each pair comprising the first image tile and the respective second image tile, a respective alignment score indicative of a degree of alignment of the first image tile with the respective second image tile, and
wherein a seam score for a candidate seam is based on an aggregate of alignment scores for image tiles traversed by the candidate seam.

4. The computer-implemented method of claim 1, wherein each of the one or more objects of interest corresponds to a human subject.

5. The computer-implemented method of claim 1, wherein the determining of the at least one seam comprises adding a computational bias to seams that contain pixels from the one or more objects of interest.

6. The computer-implemented method of claim 1, wherein the determining of the at least one seam comprises preserving at least one object of interest of the one or more objects of interest in its entirety.

7. The computer-implemented method of claim 1, wherein a respective weight associated with at least one object of interest of the one or more objects of interest is below a threshold confidence level, and wherein the determining of the at least one seam causes the at least one object of interest to not appear in the panorama image.

8. The computer-implemented method of claim 1, wherein the saliency heat maps indicative of the one or more objects of interest indicate two overlapping objects of interest, and wherein the determining of the at least one seam comprises preserving the two overlapping objects of interest in their entirety.

9. The computer-implemented method of claim 1, further comprising:
associating the at least one pair of successive image frames with respective brightness levels; and
adjusting a brightness level for the panorama image based on the respective brightness levels.

10. The computer-implemented method of claim 1, further comprising:
determining, based on a lens position, a shading adjustment for a given image frame of the at least one pair of successive image frames.

11. The computer-implemented method of claim 10, wherein the determining of the shading adjustment comprises:
retrieving, from stored memory, one or more predetermined shading adjustments associated with one or more lens positions, and
wherein the determining of the shading adjustment comprises interpolating the one or more predetermined shading adjustments based on a value of the lens position with respect to the one or more lens positions.

12. The computer-implemented method of claim 1, wherein the generating of the panorama image further comprises:
applying local tonemapping based on total exposure times (TET) associated with the at least one pair of successive image frames.

13. The computer-implemented method of claim 1, further comprising:
applying a cropped projection to the at least one pair of successive image frames.

14. The computer-implemented method of claim 13, wherein the cropped projection comprises one or more of a cylindrical projection, a spherical projection, a rectilinear projection, or a sinusoidal projection.

15. The computer-implemented method of claim 1, further comprising:
aligning the at least one pair of successive image frames based on a sensor-based alignment, an image feature based alignment, or a tile based alignment.

16. The computer-implemented method of claim 1, wherein the generating of the panorama image further comprises:
cropping the at least one pair of successive image frames to maintain a threshold image height.

17. The computer-implemented method of claim 1, wherein the generating of the panorama image further comprises:
cropping the at least one pair of successive image frames to preserve a total pixel count.

18. The computer-implemented method of claim 1, further comprising:
determining overlapping regions for the plurality of image frames;
determining optical flow fields for the overlapping regions; and
aligning the optical flow fields to generate the panorama image.

19. The computer-implemented method of claim 1, wherein the plurality of image frames are captured by a camera device in one continuous stream.

20. The computer-implemented method of claim 1, wherein the plurality of image frames are captured using a front facing camera of a camera device.

21. A computing device, comprising:
one or more processors; and
data storage, wherein the data storage has stored thereon computer-executable instructions that, when executed by the one or more processors, cause the computing device to carry out functions comprising:
receiving, by a computing device, a plurality of image frames;
determining, by the computing device, one or more objects of interest within the plurality of image frames, wherein the determining is based on saliency heat maps indicative of the one or more objects of interest;
determining at least one seam corresponding to at least one pair of successive image frames of the plurality of image frames, wherein the determining of the at least one seam is based on respective weights associated with the one or more objects of interest; and
stitching together, by the computing device and based on the at least one seam, the at least one pair of successive image frames to generate a panorama image.

22. An article of manufacture comprising one or more non-transitory computer readable media having computer-readable instructions stored thereon that, when executed by one or more processors of a computing device, cause the computing device to carry out functions comprising:
receiving, by a computing device, a plurality of image frames;
determining, by the computing device, one or more objects of interest within the plurality of image frames, wherein the determining is based on saliency heat maps indicative of the one or more objects of interest;
determining at least one seam corresponding to at least one pair of successive image frames of the plurality of image frames, wherein the determining of the at least one seam is based on respective weights associated with the one or more objects of interest; and
stitching together, by the computing device and based on the at least one scam, the at least one pair of successive image frames to generate a panorama image.
